(19) United States
(12) Patent Application Publication
(10) Pub. No.: US 2026/0016779 A1
(43) Pub. Date: Jan. 15, 2026

(54) IMAGE FORMING APPARATUS

(71) Applicant: CANON KABUSHIKI KAISHA, Tokyo (JP)

(72) Inventor: HIROYUKI SEKI, Shizuoka (JP)

(21) Appl. No.: 19/267,067

(22) Filed: Jul. 11, 2025

(30) Foreign Application Priority Data
Jul. 12, 2024 (JP) 2024-112989

(51) Int. Cl. G03G 15/23; G03G 15/00; G03G 15/01; G03G 15/08; G03G 15/16

(52) U.S. Cl. CPC G03G 15/234; G03G 15/0131; G03G 15/0189; G03G 15/0863; G03G 15/1675; G03G 15/50; G03G 15/70; G03G 15/80

(57) ABSTRACT

An image forming apparatus includes a controller which performs a continuation process in which a toner image is secondarily transferred to a back side of a sheet conveyed from a double side conveyance portion, when performing a double side print in a case in which a sheet of a feeding portion is not conveyed to a secondary transfer portion. The controller controls so that in a case of performing the continuation process, while an image formation area of the intermediary transfer belt passes through the secondary transfer portion, a predetermined voltage, which makes an outer roller be at a potential of a normal charge polarity side to an inner roller and makes an absolute value of the potential difference between the inner roller and the outer roller be less than a discharging threshold value, is applied to the secondary transfer portion.

### BACKGROUND

### Field of Technology

The present invention relates to an image forming apparatus such as a printer, a copy machine and a facsimile machine or a multifunction machine having a plurality of functions of these functions using an electrophotographic type, an electrostatic recording type or the like.

### Description of the Related Art

Conventionally, as an image forming apparatus such as a printer using an electrophotographic type, for example, an image forming apparatus of an intermediary transfer type provided with an intermediary transfer member is known. The image forming apparatus of the intermediary transfer type, after primarily transfers a toner image formed on an image bearing member onto the intermediary transfer member, secondarily transfers the toner image onto a sheet to form an image on the sheet. As an intermediary transfer member, an intermediary transfer belt stretched over a plurality of stretching rollers is widely used. In addition, the primary transfer is performed, for example, by a primary transfer voltage being applied to a primary transfer member, which is disposed opposite to the image bearing member across the intermediary transfer belt. As described in Japanese Patent Application Laid-Open No. 2013-231942, a configuration in which the primary transfer is performed by connecting a voltage maintaining element to a contact member such as a stretching roller which contacts an inner peripheral surface of the intermediary transfer belt and maintaining a primary transfer potential at a predetermined value or higher is also known. In addition, the secondary transfer is performed, for example, by a secondary transfer voltage being applied to a secondary transfer member, which is disposed opposite to one of the plurality of stretching rollers across the intermediary transfer belt. As the secondary transfer member, it is often the case that a secondary transfer roller, which contacts the one of the plurality of stretching rollers via the intermediary transfer belt to form a secondary transfer portion, is used.

The image forming apparatus may have an automatic double side conveyance function which enables to form the image on both sides of the sheet automatically without a user having to set the sheet again with reversing a front side and a back side thereof. In such an image forming apparatus, during performance of a double side print job, in a case in which the sheet becomes absent in a sheet feeding portion, there is a method to complete a print also on the back side of the sheet, of which the print has already been completed on the front side and which is waiting in a double side unit. By configuring in this manner, wasting of the sheet, of which the print has already been done on the front side, is prevented. Such operation is also referred here to as “double side print continuation process” (or simply “continuation process”).

However, in a case in which the double side print continuation process is performed as described above, before the sheet waiting in the double side unit is supplied to the secondary transfer portion, the toner image on the intermediary transfer belt, which is not transferred to the sheet, passes through the secondary transfer portion. At this time, by toner in the toner image on the intermediary transfer belt adhering to the secondary transfer roller, contamination (staining) of the back side of sheet fed from the double side unit (here, also referred to simply as “back side contamination”) may occur.

In Japanese Patent Application Laid-Open No. 2006-215369, a method for suppressing the adhesion of the toner to the secondary transfer roller by applying a voltage of opposite polarity to that applied during the transfer of the toner image onto the sheet to the secondary transfer roller at a timing when the toner image for calibration on the intermediary transfer belt passes through the secondary transfer portion is disclosed.

In the configuration which performs the double side print continuation process as described above, it is important to suppress the back side contamination described above, however, it is also important not to decrease productivity of the prints.

For example, in a case in which there is enough time before the secondary transfer to the back side of the sheet waiting in the double side unit is performed, it is conceivable to clean the secondary transfer roller during the time. However, when the prints are performed with making sheet interval wide in advance in case the sheet in the sheet feeding portion becomes absent during performance of the double side print, it is possible to suppress the back side contamination by performing the cleaning of the secondary transfer roller as described above, however, the productivity of the prints is decreased.

### SUMMARY

Therefore, an object of the present invention is, while suppressing decrease in productivity of prints, to suppress a back side contamination in a case in which a double side print continuation process is performed.

The above object is achieved with an image forming apparatus according to the present invention. In summary, the present invention is an image forming apparatus comprising: an image forming portion configured to form a toner image on an image bearing member with toner having a predetermined polarity as a normal charge polarity; a circulatable and movable intermediary transfer member to which the toner image is primarily transferred from the image bearing member at a primary transfer portion; an inner roller provided in an inner peripheral surface side of the intermediary transfer member; an outer roller in contact with the inner roller via the intermediary transfer member and configured to form a secondary transfer portion at which the toner image is secondarily transferred to a sheet from the intermediary transfer member; an applying portion configured to apply a voltage to the secondary transfer portion; a feeding portion in which the sheet is set; a conveyance portion configured to convey the sheet from the feeding portion toward the secondary transfer portion; a double side conveyance portion configured to reverse a front side and a back side of the sheet which has passed through the secondary transfer portion and to convey the sheet to the secondary transfer portion; and a control portion configured to control the image forming portion, the applying portion, the conveyance portion and the double side conveyance portion so as to perform a double side print in which the toner image is secondarily transferred to a first side and a second side of the sheet from the intermediary transfer member, and after a first toner image formed on a first image formation area on the intermediary transfer member is secondarily transferred to a first side of a first sheet conveyed to the secondary transfer portion by the conveyance portion, a second toner image formed on a second image formation area on the intermediary transfer member is secondarily transferred to a second side of a second sheet conveyed to the secondary transfer portion by the double side conveyance portion, wherein the control portion controls so that when performing the double side print, in a case in which the first sheet is not conveyed to the secondary transfer portion, a continuation process is performed in which the second toner image is secondarily transferred to the second side of the second sheet, and in a case of performing the continuation process, while the first image formation area passes through the secondary transfer portion, a predetermined voltage, which makes the outer roller be at a potential of the predetermined polarity side to the inner roller and makes an absolute value of a potential difference between the inner roller and the outer roller be less than a discharging threshold value, is applied to the secondary transfer portion by the applying portion.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an outline configuration of an image forming apparatus.

FIG. 2 is a schematic cross-sectional view illustrating an outline configuration of an image forming portion.

FIG. 3 is a block diagram illustrating an outline of a control configuration of the image forming apparatus.

FIG. 4 is a schematic view for describing a communication sequence during a double side print.

FIG. 5 is a timing chart view for describing an image forming sequence during the double side print.

FIG. 6 is a timing chart view for describing the image forming sequence in a case in which a double side print continuation process is performed.

FIG. 7 is a graph view illustrating relationship between a voltage value of a through bias and an amount of a back side contamination.

FIG. 8 is a graph view illustrating relationship between a voltage value of a sheet interval bias and the amount of the back side contamination.

FIG. 9 is a schematic view illustrating an example of a setting screen for the double side print.

FIG. 10 is a flowchart view for describing a mode selection process for the double side print.

FIG. 11 is a schematic view for describing a configuration of bias application in another example of the image forming apparatus.

FIG. 12 is a graph view for describing a setting for a through bias in the other example of the image forming apparatus.

### DESCRIPTION OF THE EMBODIMENTS

Hereinafter, an image forming apparatus according to the present invention will be described in more detail according to the drawings.

### Embodiment 1

### 1. Outline of the Image Forming Apparatus

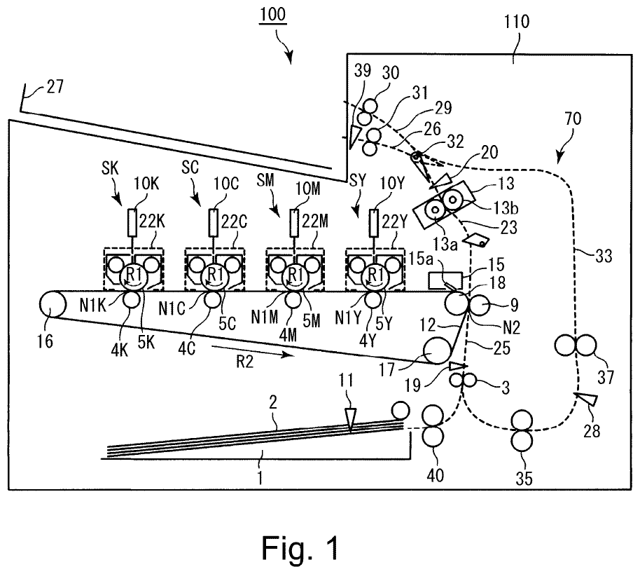

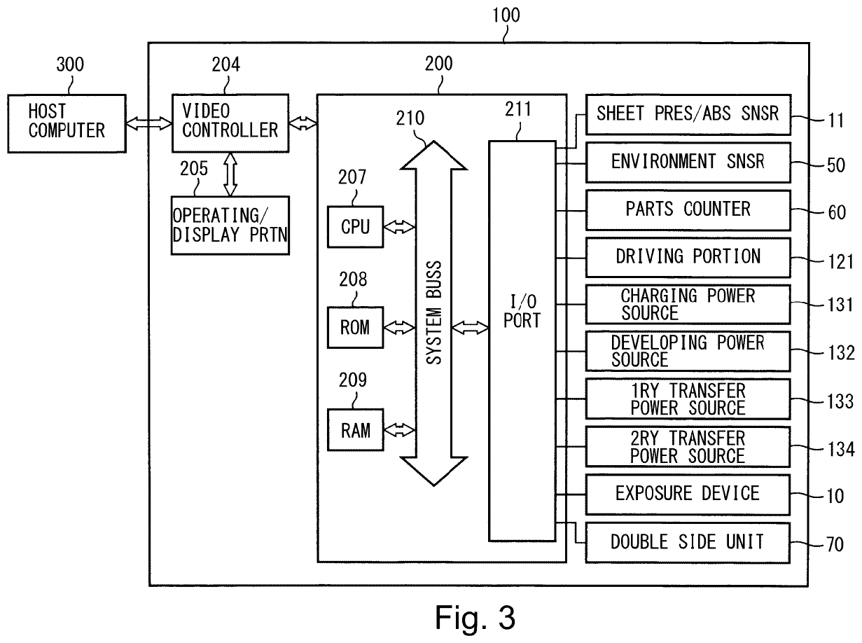

FIG. 1 is a schematic cross-sectional view illustrating an outline configuration of an image forming apparatus 100 in the present Embodiment. The image forming apparatus 100 in the present Embodiment is a laser printer of a tandem type employing an intermediary transfer type, which is capable of forming a full-color image using an electrophotographic type. The image forming apparatus (laser printer engine) 100 can form the image on a sheet 2, which is a recording material (recording medium, transfer material) having a sheet shape, based on an image signal sent from an external device 300 (FIG. 3). The external device 300 may be a host computer (personal computer, etc.), a digital camera, an image reading apparatus, etc., however, in the present Embodiment, is the host computer. Incidentally, since a paper is typically used as the sheet 2, the sheet 2 may be referred to as the paper, however, as the sheet 2, it is not limited to the paper but material other than the paper such as a plastic sheet or those formed of material including material other than the paper may also be used.

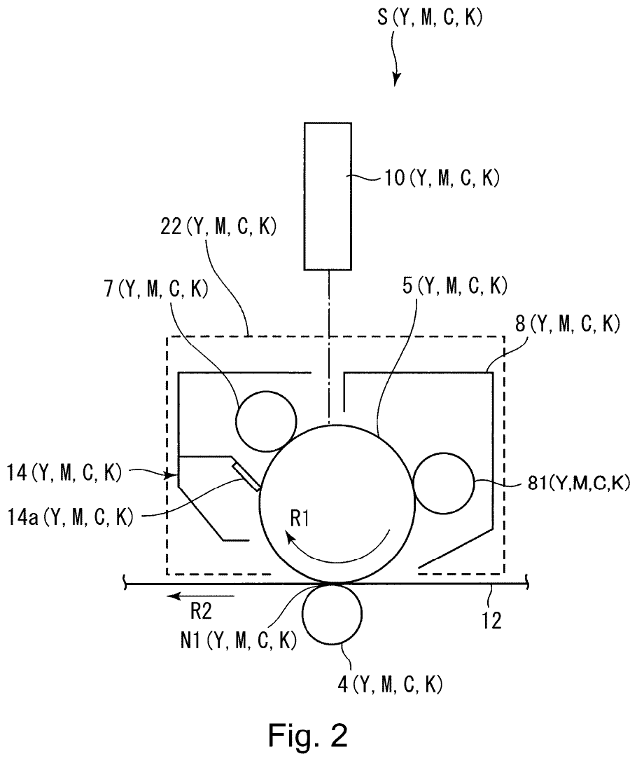

The image forming apparatus 100 is provided with four image forming portions SY, SM, SC and SK, which form yellow (Y), magenta (M), cyan (C) and black (K) images, respectively, as a plurality of image forming portions (stations, image forming units). The four image forming portions SY, SM, SC and SK are disposed side by side along a moving direction of a primary transfer surface of an intermediary transfer belt 12, which will be described below. Elements having the same or corresponding functions or configurations, which are provided for each color, may be described collectively by omitting Y, M, C and K at the ends of reference numerals indicating that the element is for either one of the colors. FIG. 2 is a schematic cross-sectional view illustrating an outline configuration of an image forming portion S.

In the present Embodiment, the image forming portion S is provided with a photosensitive drum 5 (5Y, 5M, 5C and 5K), a charging roller 7 (7Y, 7M, 7C and 7K), an exposure device 10 (10Y, 10M, 10C and 10K), a developing device 8 (8Y, 8M, 8C and 8K), a drum cleaning device 14 (14Y, 14M, 14C and 14K) etc., which will be described below.

The photosensitive drum 5, which is a rotatable photosensitive member (electrophotographic photosensitive member) having a drum shape (cylindrical shape) as an image bearing member, is rotationally driven by driving force transmitted from a driving motor of a driving portion 121 (FIG. 3) as a driving means. The photosensitive drum 5 is rotationally driven in a direction of an arrow R1 (clockwise direction) in the figure at a predetermined peripheral speed (process speed). A surface of the rotating photosensitive drum 5 is uniformly charged to predetermined potential of predetermined polarity (negative polarity in the present Embodiment) by the charging roller 7, which is a charging member having a roller shape as a charging means. During charging process, to the charging roller 7, by a charging power source 131 (FIG. 3) as a charging voltage applying means (charging voltage applying portion), predetermined charging voltage (charging bias) of the same polarity as the charge polarity of the photosensitive drum 5 (negative polarity in the present Embodiment) is applied. The charged surface of the photosensitive drum 5 is scanned and exposed by the exposure device 10 as an exposure means, and an electrostatic latent image (electrostatic image) is formed on the photosensitive drum 5.

The electrostatic latent image formed on the photosensitive drum 5 is developed (visualized) by toner as developer being supplied by the developing device 8 as a developing means, and a toner image (toner figure, developer image) is formed on the photosensitive drum 5. The developing device 8 includes a developing roller 81 as a developer carrying member (developing member), which supplies the toner to the photosensitive drum 5 by carrying and conveying the toner accommodated inside thereof. During development, to the developing roller 8, by a developing power source 132 (FIG. 3) as a developing voltage applying means (developing voltage applying portion), predetermined developing voltage (developing bias) of the same polarity as the charge polarity of the photosensitive drum 5 (negative polarity in the present Embodiment) is applied. In the present Embodiment, to an exposed portion, of which an absolute value of the potential has decreased by being exposed after being charged uniformly, on the photosensitive drum 5, the toner charged to the same polarity as the charge polarity of the photosensitive drum 5 (negative polarity in the present Embodiment) is adhered. In the present Embodiment, normal charge polarity of the toner, which is main charge polarity of the toner during development, is negative polarity.

The intermediary transfer belt 12, which is constituted by an endless belt as an intermediary transfer member, is disposed so as to oppose the four photosensitive drums 5Y, 5M, 5C and 5K. The intermediary transfer belt 12 is hooked over a tension roller 16, a pre-secondary transfer roller 17 and a driving roller 18 as the plurality of stretching rollers, and is stretched at predetermined tensile force. The intermediary transfer belt 12, by driving force being input by the driving roller 18 being rotationally driven by the driving force being transmitted from the driving motor of the driving portion 121 (FIG. 3), is rotated (circularly moved) in a direction of an arrow R2 (counterclockwise direction) in the figure at substantially the same peripheral speed as the peripheral speed of the photosensitive drum 5. By the driving roller 18, the tension roller 16 and the pre-secondary transfer roller 17, the primary transfer surface of the intermediary transfer belt 12, to which the toner image is transferred from the photosensitive drum 5, is formed. On an inner peripheral surface side of the intermediary transfer belt 12, corresponding to the four photosensitive drums 5Y, 5M, 5C and 5K, primary transfer rollers 4Y, 4M, 4C and 4K, which are primary transfer members having roller shapes as primary transfer means, are disposed, respectively. The primary transfer roller 4 presses the intermediary transfer belt 12 toward the photosensitive drum 5 and forms a primary transfer portion (primary transfer nip portion, primary transfer position) N1 (N1Y, N1M, N1C and N1K), which is a contact portion between the photosensitive drum 5 and the intermediary transfer belt 12. The stretching rollers other than the driving roller 18 and each primary transfer roller 5 are rotated following the rotation of the intermediary transfer belt 12.

The toner image formed on the photosensitive drum 5 is transferred (primarily transferred), in the primary transfer portion N1, by an action of the primary transfer roller 4, onto the intermediary transfer belt 12. To the primary transfer roller 4, a primary transfer power source 133 (FIG. 3) as a primary transfer voltage applying means (primary transfer voltage applying portion) is connected. During primary transfer, to the primary transfer roller 4, by the primary transfer power source 133, a predetermined primary transfer voltage (primary transfer bias), which is a direct current voltage of an opposite polarity to the normal charge polarity of the toner (positive polarity in the present Embodiment), is applied. During full-color image formation, for example, the toner images of each color of yellow, magenta, cyan and black, which are formed on each photosensitive drum 5, are sequentially transferred so as to be superimposed on the same image formation area (area in which the toner image is to be formed) on the intermediary transfer belt 12. In addition, the toner remaining on the photosensitive drum 5 after the primary transfer (primary transfer residual toner) is removed from the photosensitive drum 5 and collected by the drum cleaning device 14 as a photosensitive member cleaning means. In the present Embodiment, the primary transfer residual toner is scraped off, by a cleaning blade 14a as a cleaning member which is disposed so as to be in contact with the surface of the photosensitive drum 5, from the surface of the rotating photosensitive drum 5 and collected.

On an outer peripheral surface side of the intermediary transfer belt 12, at an opposing position to the driving roller 18, which has a function of a secondary transfer opposite roller (secondary transfer inner roller), a secondary transfer roller (secondary transfer outer roller) 9, which is a secondary transfer member having a roller shape as a secondary transfer means, is disposed. The secondary transfer roller 9 is pressed toward the driving roller 18, is in contact with the driving roller 18 via the intermediary transfer belt 12, and forms a secondary transfer portion (secondary transfer nip portion, secondary transfer position) N2, which is a contact portion between the intermediary transfer belt 12 and the secondary transfer roller 9. The secondary transfer roller 9 is rotated following the rotation of the intermediary transfer belt 12 in the present Embodiment, but may be configured to be rotationally driven. The toner image formed on the intermediary transfer belt 12 is transferred (secondarily transferred), in the secondary transfer portion N2, by an action of the secondary transfer roller 9, onto the sheet 2, which is nipped and conveyed by the intermediary transfer belt 12 and the secondary transfer roller 9. To the secondary transfer roller 8, a secondary transfer power source 134 (FIG. 3) as a secondary transfer voltage applying means (secondary transfer voltage applying portion) is connected. During secondary transfer, to the secondary transfer roller 8, by the secondary transfer power source 134, a predetermined secondary transfer voltage (secondary transfer bias), which is a direct current voltage of the opposite polarity to the normal charge polarity of the toner (positive polarity in the present Embodiment), is applied. In the present Embodiment, the driving roller 18 is electrically grounded (connected to ground potential). Incidentally, in the present Embodiment, the tension roller 16 and the pre-secondary transfer roller 17 are also electrically grounded. In addition, adherent material such as the toner remaining on the intermediary transfer belt 12 after the secondary transfer (secondary transfer residual toner) is removed from the intermediary transfer belt 12 and collected by a belt cleaning device 15 as an intermediary transfer member cleaning means. The belt cleaning device 15 is disposed, in the rotational direction of the intermediary transfer belt 12, downstream of the secondary transfer portion N2 and upstream of the primary transfer portion N1 (upstreammost primary transfer portion N1Y) and facing the intermediary transfer belt 12. In the present Embodiment, the belt cleaning device 15 scrapes off and collects, with a cleaning blade 15a as a cleaning member, which is disposed so as to be in contact with a surface of the intermediary transfer belt 12, the adherent material from the surface of the rotating intermediary transfer belt 12.

The sheet 2 is accommodated in a sheet feeding portion (sheet feeding cassette, feeding portion) 1. The sheet 2 is fed out one by one from the sheet feeding portion 1 by a sheet feeding roller 40, etc. as a sheet feeding member, and conveyed to a registration roller 3 as a conveyance member. And this sheet 2 is conveyed, by the registration roller 3, through a sheet feeding conveyance passage 25 so as to be timed with the toner image on the intermediary transfer belt 12, and is supplied to the secondary transfer portion N2. In the present Embodiment, by the sheet feeding roller 40, a conveyance portion which conveys the sheet 2 from the sheet feeding portion 1 to the secondary transfer portion N2 is constituted. Incidentally, the sheet feeding portion is not limited to the sheet feeding cassette, but may be instead of or in addition to the sheet feeding cassette, for example, a manual feed tray provided to the image forming apparatus 100.

The sheet 2 onto which the toner image has been transferred is conveyed through a pre fixing conveyance passage 23 to a fixing device 13 as a fixing means. In the present Embodiment, the fixing device 13 includes a fixing roller 13a, which heats the sheet 2, and a pressing roller 13b, which brings the sheet 2 into press contact to the fixing roller 13a. The fixing roller 13a and the pressing roller 13b are formed in hollow shapes, and an inside of the fixing roller 13a, a heater is incorporated. The fixing device 13 fixes (melts, mixes the colors, solidly fixes), by heating and pressurizing the sheet 2 carrying the unfixed toner image thereon, the toner image onto the sheet 2. The sheet 2 onto which the toner image has been fixed is conveyed through a sheet discharging conveyance passage 26 and, by a sheet discharging conveyance roller 31, etc. as a conveyance member, is discharged (output) to a sheet discharge portion (sheet discharge tray) 27, which is provided outside (outside the machine) ofa main assembly 110 of the imaging forming apparatus 100. Incidentally, a double side print will be described below.

Here, in the present Embodiment, the photosensitive drum 5 is an OPC (organic photoconductive member) drum constituted by an organic photoconductive layer being applied to an outer periphery of an aluminum cylinder.

In addition, in the present Embodiment, the exposure device 10 is constituted by a laser scanner device. The exposure device 10 forms, by selectively exposing the surface of the photosensitive drum 5, which is charged uniformly, according to image information (image signal), the electrostatic latent image on the photosensitive drum 5.

In addition, in the present Embodiment, the primary transfer roller 4 is an elastic roller constituted by covering an outer periphery of a nickel-plated steel rod having an outer diameter of 6 mm with a foam sponge member, whose main components are NBR and epichlorohydrin rubber, whose volume resistivity is adjusted to 1×10⁶ Ω cm and a thickness is adjusted to 4 mm. The primary transfer roller 4 is pressed against the photosensitive drum 5 across the intermediary transfer belt 12.

In addition, in the present Embodiment, the secondary transfer roller 9 is an elastic roller constituted by covering a nickel-plated steel rod having an outer diameter of 8 mm with a foam sponge member, whose main components are NBR and epichlorohydrin rubber, whose volume resistivity is adjusted to 1×10⁸ Ω cm and a thickness is adjusted to 5 mm. In other words, in the present Embodiment, an outer diameter of the secondary transfer roller 9 is 18 mm. In addition, in the present Embodiment, the secondary transfer roller 9 contacts an outer peripheral surface of the intermediary transfer belt 12 with pressing force of 50N, and forms the secondary transfer portion N2. In addition, in the present Embodiment, the secondary transfer roller 9 is rotated following the rotation of the intermediary transfer belt 12. In addition, in the present Embodiment, upon secondarily transferring the toner image on the intermediary transfer belt 12 to the sheet 2, a secondary transfer voltage of the positive polarity of about 2500 V is applied to the secondary transfer roller 9 by the secondary transfer power source 134.

In addition, in the present Embodiment, the intermediary transfer belt 12 has a peripheral length of 700 mm, a thickness of 90 m, and is constituted by an endless belt, which is formed using polyimide resin in which carbon is mixed as a conductive agent. In the present Embodiment, as for electrical characteristics, the intermediary transfer belt 12 exhibits electroconductive property and is characterized in that a resistance value has small fluctuation to temperature and humidity in the atmosphere. In the present Embodiment, polyimide resin is used as material for the intermediary transfer belt 12, however, the material for the intermediary transfer belt 12 is not limited to this but, for example, other thermoplastic resins may be used. For example, material such as polyester, polycarbonate, polyarylate, acrylonitrile-butadiene-styrene copolymer (ABS), polyphenylene sulfide (PPS), polyvinylidene fluoride (PVdF), or a mixed resin of these is included. In addition, the conductive agent is not limited to carbon, but for example, conductive metal oxide particles may be used. In the present Embodiment, a volume resistivity of the intermediary transfer belt 12 is 1×10⁹ Ω cm. The volume resistivity is measured by Hiresta-UP (MCP-HT450) manufactured by Nittoseiko Analytech Co., Ltd. using a ring probe type UR (model MCP-HTP12). For a measuring condition, it is set that an indoor temperature to 23° C., an indoor humidity to 55%, an applied voltage to 100 V, and a measurement time to 10 sec. In the present Embodiment, the volume resistivity of the intermediary transfer belt 12 is preferably in a range of 1×10⁷-10¹⁰ Ω cm. Incidentally, for a numerical range, “-” means that values before and after the symbol are included.

Incidentally, in the conveyance passages of the sheet 2 in the image forming apparatus 100, a registration sensor 19, a fixing and discharging sensor 20 and a double side conveyance sensor 28, which are capable of detecting a leading end and a trailing end of the conveyed sheet 2, are disposed. In addition, at a sheet feeding port of the sheet feeding portion 1, a sheet presence/absence sensor 11 as a sheet presence/absence detecting means for detecting presence or absence of the sheet 2 is provided. In addition, at a sheet discharging port of the apparatus main assembly 110, a full load detecting sensor 39 for detecting full load of the sheet 2 in the sheet discharge portion 27 is provided. In addition, in the apparatus main assembly 110, an environment sensor 50 (FIG. 3), which is capable of detecting temperature and humidity in a use environment (installed environment) of the image forming apparatus 100 is provided.

In addition, in the present Embodiment, in each image forming portion S, the photosensitive drum 5 and the charging roller 7, the developing roller 8 and the drum cleaning device 14, which act on the photosensitive drum 5 as process means, constitute a process cartridge 22, which is integrally mountable to and demountable from the apparatus main assembly 110. The process cartridge 22 can be replaced by a user in a case, for example, in which the toner in the developing device 8 runs out. Incidentally, in the present Embodiment, the main assembly of the image forming apparatus 100 corresponds to a portion of the image forming apparatus 100 minus each process cartridge 22 (22Y, 22M, 22C, 22K).

In addition, in the present Embodiment, the image forming apparatus 100 does not include a mechanism for separating the secondary transfer roller 9 from the intermediary transfer belt 12 in the apparatus main assembly 110.

### 2. Double Side Unit

Next, a configuration and operation of a double side unit (double side conveyance mechanism) 70 as a double side conveyance means (double side conveyance portion) for performing the prints on both sides of the sheet 2 in the present Embodiment will be described. The image forming apparatus 100 in the present Embodiment is configured so as to be capable of performing a double side print (automatic double side print) using the double side unit 70.

The sheet 2, of which the toner image has been transferred onto a front side and which has passed through the fixing device 13, is conveyed, by a position of a double side flapper 32 being switched by a reversing clutch (not shown), to a double side reversing passage 29. When the trailing end of the sheet 2 reaches the double side reversing passage 29, by the reversing clutch, a rotational direction of a reversing roller 30 is switched and the position of the double side flapper 32 is switched, and the sheet 2 is conveyed to a double side conveyance passage 33. The sheet 2, of which a conveyance direction is reversed, is conveyed through the double side conveyance passage 33 by a double side conveyance roller 37 and a double side sheet re-feeding roller 35. By the reversing clutch, the double side flapper 32, the double side reversing passage 29, the reversing roller 30, the double side conveyance passage 33, the double side conveyance roller 37 and the double side sheet re-feeding roller 35, etc., the double side unit 70 is constituted.

In this manner, the sheet 2 is conveyed to the registration roller 3 in a state in which the front side and the back side thereof is reversed, is conveyed again through the sheet feeding conveyance passage 25 by the registration roller 3, and is supplied to the secondary transfer portion N2. And the transfer and the fixing of the toner image onto the back side of the sheet 2 is performed, and the sheet 2 is discharged to the sheet discharge portion 27.

Incidentally, in the present Embodiment, during double side print, a distance in the conveyance direction of the sheet 2 between the preceding sheet 2 and the next sheet 2, which are conveyed to the secondary transfer portion N2, (here, also referred to as a “sheet interval”) is 20 mm. In other words, in the present Embodiment, the sheet interval during double side print is shorter than 56.5 mm, which is a length of one round (peripheral length) of the secondary transfer roller 9. By configuring the sheet interval as short as possible, productivity of the prints can be increased.

### 3. Control Configuration

Next, a control configuration of the image forming apparatus 100 in the present Embodiment will be described. FIG. 3 is a block diagram illustrating an outline of the control configuration of the image forming apparatus 100 in the present Embodiment.

The image forming apparatus 100 includes an operating and display portion 205, a video controller (image processing portion) 204 and an engine control portion (control portion) 200.

The video controller 204 sends information, which indicates a state of the image forming apparatus 100, etc., and is received from the engine control portion 200, to the operating and display portion (operation panel) 205. The operating and display portion 205 switches, based on the received information indicating the state of the image forming apparatus 100, etc., a display in the operating and display portion 205. The operating and display portion 205 includes a display portion for displaying information to a user (operator) by control of the engine control portion 200, and an input portion such as an operating button for inputting information to the engine control portion 200 based on an operation of the user (operator). The operating and display portion 205 may be configured to include a touch panel, which has the function of the display portion and the function of the input portion. In addition, the video controller 204 receives the image information and a print instruction from the host computer 300. The video controller 204 analyzes the received image information to convert to bitmap data, and sends out, via a video interface portion (not shown), for each page, a print (printing) reserve command, a print (printing) start command and a video signal to the engine control portion 200.

The engine control portion 200 is constituted by a control IC, which includes a CPU 207 which is an arithmetic process portion, a ROM 208 and a RAM 209 which are storage portions, and an I/O port 211 which is an input/output portion. The CPU 207 loads programs and various types of data from the ROM 208, and by using the RAM 209 as a work area thereof, executes the programs and control the image forming apparatus 100 collectively. The CPU 207, the ROM 208 and the RAM 209 are accessible to the I/O port 211 via a system bus 210, which is bi-directionally accessible. To each I/O port 211, various types of actuators of the image forming apparatus 100 are connected. For example, to the I/O port 211, the driving portion 121, the charging power source 131, the developing power source 132, the primary transfer power source 133, the secondary transfer power source 134, the exposure device 10, and the reversing clutch (not shown) of the double side unit 70 are connected. The engine control portion 200 controls, via I/O port 211, the various types of actuators to perform the conveyance of the sheet 2, the image formation, an initializing operation, etc. In addition, to the I/O port 211, for example, the sheet presence/absence sensor 11 in the sheet feeding portion 1 is connected. The engine control portion 200 acquires, via the I/O port, a signal indicating a detection result of the presence or absence of the sheet 2 in the sheet feeding portion 1 by the sheet presence/absence sensor 11. In addition, to the I/O port 211, for example, the environment sensor 50 is connected. The engine control portion 200 acquires, via the I/O port 211, a signal indicating a detection result of the temperature and the humidity in the use environment of the image forming apparatus 100 by the environmental sensor 50. Incidentally, the environment may be at least one of the temperature and the humidity of at least one of inside and outside the image forming apparatus 100. In the present Embodiment, the environment sensor 50 detects the temperature and the humidity inside the image forming apparatus 100.

Other than these, not shown in the figure, however, to the I/O port 211, the registration sensor 19, the fixing and discharging sensor 20, the double side conveyance sensor 28, the full load detecting sensor 39, etc. are connected, and the engine control portion 200 can acquire signals indicating detection results of each of these sensors.

Incidentally, although not shown in the figure, in the present Embodiment, the charging power source 131, the developing power source 132, the primary transfer power source 133 and the exposure device 10 are provided independently for each image forming portion S. However, at least one of these may be commonized to the plurality of the image forming portions S. In addition, to the driving portion 121, the driving motor as a driving source for driving driving targets such as the photosensitive drum 5, the driving roller 18, the various types of the rollers which perform the conveyance of the sheet 2, and the fixing device 13 is provided. The driving motor may be provided independently for each driving target, or driving motors may be commonized for a plurality of the driving targets.

In addition, in the present Embodiment, the secondary transfer power source 134 is configured so as to output the bias by a constant voltage control which adjusts the output so that an output voltage is a target voltage. In addition, in the present Embodiment, the secondary transfer power source 134 is configured so as to be capable of outputting the bias of positive polarity (positive bias) and the bias of negative polarity (negative bias). In other words, in the present Embodiment, the secondary transfer power source 134 includes a positive bias output portion and a negative bias output portion.

In addition, in FIG. 3, for convenience, a parts counter 60, which will be described in an Embodiment 2, is illustrated as well.

Here, the image forming apparatus 100 performs a job (print job, image forming sequence), which is started by a single start instruction and is a series of operations to form and output the image on a single or a plurality of the sheets 2. The job generally includes an image forming process, a pre rotation process, a sheet interval process in a case in which the images are formed on a plurality of the sheets 2, and a post rotation process. The image forming process is a period during which the formation of the electrostatic image of the image to be actually formed and output on the sheet 2, the formation of the toner image, and the transfer of the toner image are performed, and “during image formation” refers to this period. In more detail, timings of the “during image formation” differ at positions, at which each process of the formation of the electrostatic image, the formation of the toner image and the transfer of the toner image is performed. The pre rotation process is a period from when the start instruction being input until when the image is actually begins to be formed, during which preparatory operation prior to the image forming process is performed. The sheet interval process is a period corresponding to the interval between the sheet 2 and the sheet 2 upon performing the image formation continuously for a plurality of the sheets 2 (continuous image formation). The post rotation process is a period during which organizing operations (preparatory operations) after the image forming process are performed. “During non-image formation” is a period other than the “during image formation”, and includes the pre rotation process, the sheet interval process and the post rotation process described above, furthermore, a pre-multi-rotation process, which is a preparatory operation when the image forming apparatus 100 is turned on or returns from a sleep state.

### 4. Double Side Print

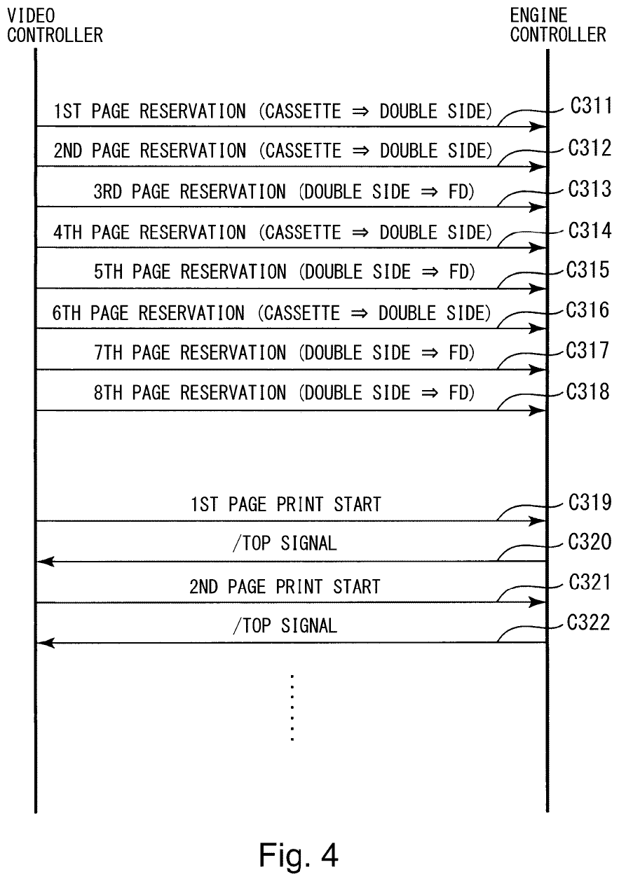

FIG. 4 is a schematic view for describing a communication sequence between the engine control portion 200 and the video controller 204 in a case in which the sheet feedings from the sheet feeding portion 1 and from the double side unit 70 (double side conveyance passage 33) are alternately performed and the double side prints for four sheets are performed. In the present Embodiment, the engine control portion 200 functions as a main control portion which performs the control of the conveyance operation for the sheet 2 and the image forming operation in the image forming apparatus 100.

First, the video controller 204 sends, to the engine control portion 200, a reserve command (print reserve command), which feeds the sheet from the sheet feeding portion 1 and discharge the sheet to the double side unit 70, as a first page reservation (C311). Next, the video controller 204 sends a reserve command, to the engine control portion 200, which feeds the sheet from the sheet feeding portion 1 and discharge the sheet to the double side unit 70, as a second page reservation (C312). Next, the video controller 204 sends a reserve command, to the engine control portion 200, which feeds the sheet from the double side unit 70 and discharge the sheet to the sheet discharge portion 27 outside the machine of the image forming apparatus 100, as a third page reservation (C313). This page is a reservation for the back side of the first page. The sending of the reservation command is repeated also for a rest of reservation IDs (fourth-eighth page) in the same manner (C314, C315, C316, C317 and C318).

Next, the video controller 204 outputs, to the engine control portion 200, the start command (print start command) for the first page, which is reserved by the reserve command (C319). The engine control portion 200 starts the image forming sequence (rotation of the photosensitive drum 5, the charging process) after receiving the start command, and outputs a/TOP signal to the video controller 204 at a predetermined timing when the image formation becomes possible (C320). And by the video controller 204 outputting a video signal for the first page in synchronization with the/TOP signal (not shown in figure), the image forming apparatus 100 starts the image formation (exposure process, developing process) for the first page in accordance with the video signal by the control of the engine control portion 200. When the output of the video signal for the first page is completed, the video controller 204 outputs the start command for the next reserved page (C321). Thereafter, the output of the start command and the output of the/TOP signal are performed repeatedly also for the rest of the reserved pages (third-eighth page) in the same manner, and the image formations are performed for the rest of the pages.

Incidentally, as indicated by the reserve commands from C311 to C318, making the single sheet 2 wait in the double side unit 70 and alternately performing the sheet feeding from the sheet feeding portion 1 and the sheet feeding from the double side unit 70 is also referred to here as a “two sheet alternate double side print”.

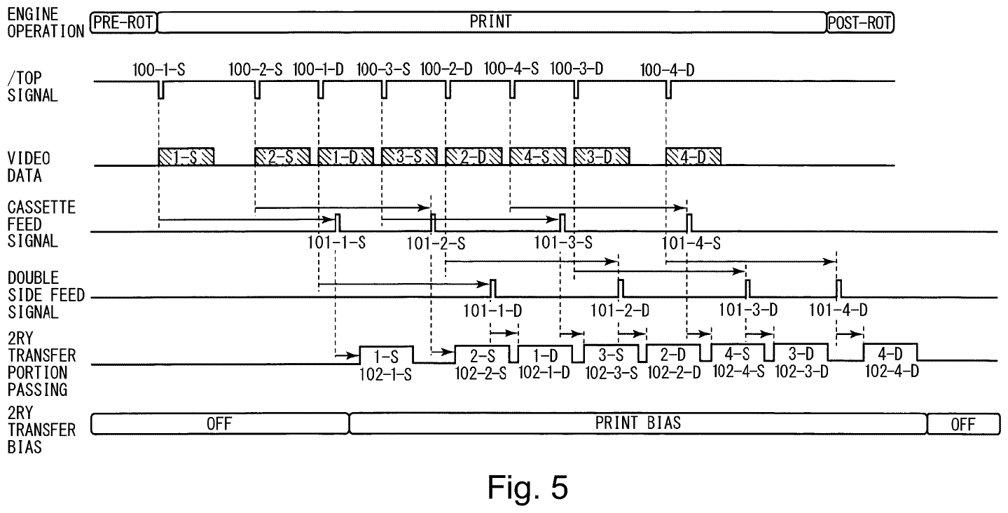

FIG. 5 is a timing chart diagram illustrating the image forming sequence in the case in which the image formation is performed in accordance with the communication sequence for the two sheet alternate double side print described using FIG. 4. Incidentally, here, in the double side print, a side of the sheet 2, onto which the toner image is transferred upon being fed from the sheet feeding portion 1 and discharged to the double side unit 70, is referred to as the “front side”. In addition, a side of the sheet 2, onto which the toner image is transferred upon being fed from the double side unit 70 and discharged outside the machine of the image forming apparatus 100 is referred to as the “back side”. In other words, in the double side print, a side to which the toner image is firstly transferred on the sheet 2, which is fed from the sheet feeding portion 1 and supplied to the secondary transfer portion N2, is the front side (first side). And a side (opposite side to the front side) of the sheet 2 to which the toner image is transferred by that sheet 2 being fed from the double side unit 70 and supplied to the secondary transfer portion N2 is the back side (second side). In addition, with respect to the image formation area, the toner image or the sheet 2, a “leading end” and a “trailing end” refers to a leading end and a trailing end in moving directions (conveyance directions) thereof. In addition, for simplicity, here, it will be described as the toner image is formed in an entire area of each image formation area on the intermediary transfer belt 12. Thus, here, for example, a period during which the toner image on the intermediary transfer belt 12 is passing through the secondary transfer portion N2 equals to a period during which the image formation area, in which that toner image on the intermediary transfer belt 12 is to be formed, is passing through the secondary transfer portion N2.

Upon receiving the start command corresponding to the reserve command for the front side of the first sheet (print ID=1), the engine control portion 200 controls to start a pre rotation sequence (the pre rotation process). After completion of the pre rotation sequence, the engine control portion 200 outputs the/TOP signal (100-1-S) to control to start the image forming operation (image forming process) for the front side of the first sheet. The engine control portion 200 controls to form the toner image on the intermediary transfer belt 12 according to the video signal (1-S) sent out from the video controller 204. In addition, after a predetermined time from the/TOP signal, the engine control portion 200 outputs a cassette sheet feeding signal to control to start the conveyance of the sheet 2 from the sheet feeding portion 1 (101-1-S). At this time, the engine control portion 200 controls to supply the sheet 2 to the secondary transfer portion 2 in synchronization with the toner image formed on the intermediary transfer belt 12 reaching the secondary transfer portion N2.

In the present Embodiment, when the leading end of the sheet 2 fed from the sheet feeding portion 1 is detected by the registration sensor 19, the engine control portion 200 controls to perform acceleration/deceleration of the conveyance of the sheet 2 by the registration roller 3 as appropriate. By this, the engine control portion 200 controls so that the leading end of the toner image formed on the intermediary transfer belt 12 and the leading end of the sheet 2 are aligned at the secondary transfer portion N2. After a predetermined time from the engine control portion 200 having performed the output of the cassette sheet feeding signal (sheet feeding instruction), the toner image formed on the intermediary transfer belt 12 and the sheet 2 fed from the sheet feeding portion 1 pass through the secondary transfer portion N2 (102-1-S). As a result, the toner image (1-S) is transferred from the intermediary transfer belt 12 onto the sheet 2. At this time, the engine control portion 200 controls, upon the toner image on the intermediary transfer belt 12 being passing through the secondary transfer portion N2, to the secondary transfer roller 9, to apply a first secondary transfer voltage (here, also referred to as “print bias”) to transfer the toner image onto the sheet 2. In the present Embodiment, the application of the print bias is started before the sheet 2, which is conveyed to the secondary transfer portion N2 for the secondary transfer of the toner image for the first page (front side of the first sheet), reaches the secondary transfer portion N2. And the application of the print bias is continued until after the sheet 2, which is conveyed to the secondary transfer portion N2 for the secondary transfer of the toner image for a last page (back side of the fourth sheet), has passed through the secondary transfer portion N2. The toner image for the front side of the first sheet, which has been transferred onto the sheet 2, is heated and fixed onto the sheet 2 by the fixing device 13. By this, the image formation for the front side of the first sheet is completed. The first sheet 2, of which the image formation for the front side thereof is performed, is conveyed to the double side unit 70.

Similarly, upon receiving the start command corresponding to the reserve command for the front side of the second sheet (print ID=2), the engine control portion 200 outputs the/TOP signal (100-2-S), and controls to start the image forming operation for the front side of the second sheet. The engine control portion 200 controls to form the toner image on the intermediary transfer belt 12 according to the video signal (2-S) sent out from the video controller 204. In addition, after a predetermined time from the/TOP signal, the engine control portion 200 outputs the cassette sheet feeding signal to control to start the conveyance of the sheet 2 from the sheet feeding portion 1 (101-2-S). After a predetermined time from the engine control portion 200 having performed the output of the cassette sheet feeding signal (sheet feeding instruction), the toner image formed on the intermediary transfer belt 12 and the sheet 2 fed from the sheet feeding portion 1 pass through the secondary transfer portion N2 (102-2-S). As a result, the toner image (2-S) is transferred from the intermediary transfer belt 12 onto the sheet 2.

The toner image for the front side of the second sheet, which has been transferred onto the sheet 2, is heated and fixed onto the sheet 2 by the fixing device 13. By this, the image formation for the front side of the second sheet is completed. The second sheet 2, of which the image formation for the front side thereof is performed, is conveyed to the double side unit 70.

Next, upon receiving the start command corresponding to the reserve command for the back side of the first sheet (print ID=1), the engine control portion 200 outputs the/TOP signal (100-1-D), and controls to start the image forming operation for the back side of the first sheet. The engine control portion 200 controls to form the toner image on the intermediary transfer belt 12 according to the video signal (1-D) sent out from the video controller 204. In addition, after a predetermined time from the/TOP signal, the engine control portion 200 outputs a double side sheet feeding signal to control to start the conveyance of the sheet 2 from the double side unit 70 (101-1-D). After a predetermined time from the engine control portion 200 having performed the output of the double side sheet feeding signal (sheet feeding instruction), the toner image formed on the intermediary transfer belt 12 and the sheet 2 fed from the double side unit 70 pass through the secondary transfer portion N2 (102-1-D).

As a result, the toner image (1-D) is transferred from the intermediary transfer belt 12 onto the sheet 2. The toner image for the back side of the first sheet, which has been transferred onto the sheet 2, is heated and fixed onto the sheet 2 by the fixing device 13. By this, the image formation for the front side and the back side of the first sheet is completed. The first sheet 2, for which the image formation is completed on both the front side and the back side, is discharged outside the machine of the image forming apparatus 100.

The operation described above is repeated for the four sheets. The engine control portion 200 controls to perform a post rotation sequence (the post rotation process) when all of the image formations (formations of the toner images) are completed. In addition, the engine control portion 200 controls, after the sheet 2, on which a last toner image (the toner image for the back side of the fourth sheet) is transferred, has passed through the secondary transfer portion N2, to stop the output of the print bias, which has been applied to the secondary transfer roller 9. According to the above, the double side prints for the four sheets are completed.

As described above, in the present Embodiment, the sheet interval during double side print is 20 mm, which is shorter than 56.5 mm, which is the length of one round (peripheral length) of the secondary transfer roller 9. Incidentally, this sheet interval during double side print is represented by the sheet interval between the sheet 2 fed from the sheet feeding portion 1 and the sheet 2 fed from the double side unit 70 next thereto. As shown in FIG. 5, during double side print, the sheet interval between the first sheet 2 (front side) and the second sheet 2 (front side), which are continuously fed from the sheet feeding portion 1, and the sheet interval between the last sheet 2 (back side) and the sheet 2 (back side), which is one sheet previous to the last sheet 2, which are continuously fed from the double side unit 70, may become longer, due to switching of the conveyance direction of the sheet 2 in the double side unit 70, than the other sheet intervals. The configuration in which the sheet interval during double side print is shorter than the length of one round of the secondary transfer roller 9 is, in other words, during double side print, a configuration in which a first period from when the trailing end of the sheet 2, which is fed from the sheet feeding portion 1, reaches the secondary transfer portion N2 until when the leading end of the sheet 2, which is fed from the double side unit 70 next thereto, is shorter than a second period when the secondary transfer roller 9 makes one round.

5. Operation in a Case in which the Sheet in the Sheet Feeding Portion Becomes Absent

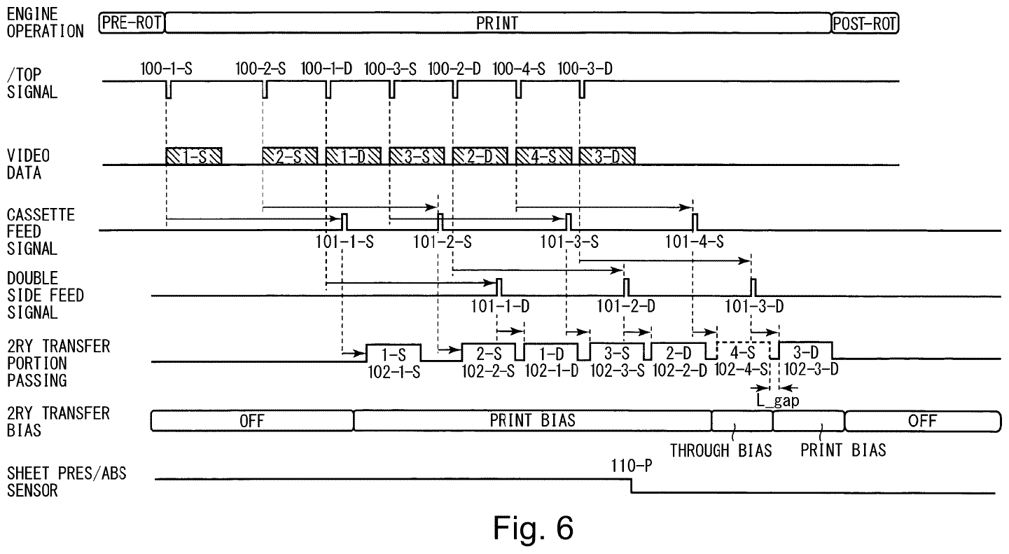

FIG. 6 is a timing chart diagram illustrating the image forming sequence in a case in which, during performance of the image forming sequence according to the communication sequence for the two sheet alternate double side print described using FIG. 4, the sheet 2 in the sheet feeding portion 1 becomes absent in a turn for the fourth sheet. In FIG. 6, for events and timings which are the same as those in FIG. 5, the same reference numerals as in FIG. 5 are attached, and detailed description thereof will be omitted.

As shown in FIG. 6, the engine control portion 200 acquires, at a timing 110-P, a detection signal by the sheet presence/absence sensor 11 indicating that the fourth sheet 2 is absent in the sheet feeding portion 1. At this timing 110-P, already, the/TOP signal (100-4-S) for the front side of the fourth sheet has been output and the image formation (formation of the toner image) for the front side of the fourth sheet has been completed. In addition, at this timing 110-P, already, the/TOP signal (100-3-D) for the back side of the third sheet, which is next to the front side of the fourth sheet, has been output and the image formation (formation of the toner image) for the back side of the third sheet has been started.

In the present Embodiment, in the case in which the sheet 2 in the sheet feeding portion 1 becomes absent during performance of the double side print in this manner, the image forming apparatus 100 performs a “double side print continuation process”, which completes the print for the back side of the sheet 2, of which the print for the front side has been completed and which is waiting in the double side unit 70. Incidentally, after the double side print continuation process is performed, typically, by the sheet 2 being replenished to the sheet feeding portion 1 by a user, the job is resumed, and by the print for the front side of the fourth sheet and the print for the back side of the fourth sheet being performed, the job is completed.

Here, since the sheet 2 in the sheet feeding portion 1 becomes absent, the fourth sheet 2 is not conveyed to the secondary transfer portion (nip portion between the intermediary transfer belt 12 and the secondary transfer roller 9) N2. Therefore, it is necessary to make the toner image (4-S) for the front side of the fourth sheet, which has been formed on the intermediary transfer belt 12, pass through the secondary transfer portion N2. And, thereafter, it is necessary to transfer the toner image for the back side of the third sheet (3-D), which has been formed on the intermediary transfer belt 12, to the sheet 2 conveyed from the double side unit 70.

In this manner, the toner image, which is primarily transferred onto the intermediary transfer belt 12 and passes through the secondary transfer portion N2 without being secondarily transferred to the sheet 2, is also referred to here as a “non-transferred toner image”. If the toner adheres to the secondary transfer roller 9 upon the non-transferred toner image (4-S) for the front side of the fourth sheet passing through the secondary transfer portion N2, upon performing the subsequent secondary transfer of the toner image for the back side of the third sheet (3-D), “back side contamination” may occur.

In the configuration which performs the double side print continuation process, it is important to suppress the back side contamination described above, however, it is also important not to decrease the productivity of the prints.

For example, in a case in which there is enough time from when the non-transferred toner image on the intermediary transfer belt 12 passes through the secondary transfer portion N2 until when the secondary transfer to the back side of the sheet 2, which is waiting in the double side unit 70, is performed, it is conceivable to clean the secondary transfer roller 9 during the time. For example, it is possible, by applying voltages of both of positive and negative polarity to the secondary transfer roller 9 for a certain period of time alternately, etc., to transfer the toner adhered to the secondary transfer roller 9 to the intermediary transfer belt 12, and collect the toner from the intermediary transfer belt 12 by the belt cleaning device 15, etc. However, in the image forming apparatus 100 of the intermediary transfer type, as described above, upon the absence of the sheet 2 in the sheet feeding portion 1 being detected during performance of the double side print job, there is a case in which the formation of at least a portion of the toner image to be transferred to the front side of that sheet 2 and the toner image to be transferred to the back side of the sheet 2, which is waiting in the double side unit 70, has already been completed. Therefore, when the prints are performed with making the sheet interval wide in advance in case the sheet 2 in the sheet feeding portion 1 becomes absent during performance of the double side print, it is possible to suppress the back side contamination by performing the cleaning of the secondary transfer roller as described above, however, the productivity of the prints is decreased.

Therefore, there is a need, while suppressing the decrease in the productivity of the prints, to suppress the back side contamination in the case in which the double side print continuation process is performed.

### 6. Through Bias

Therefore, in the present Embodiment, the engine control unit 200 controls, upon the non-transferred toner image on the intermediary transfer belt 12 being passing through the secondary transfer portion N2, to apply, to the secondary transfer roller 9, a second secondary transfer voltage (here, also referred to as a “through bias”). Typically, over a period when an entire area of the non-transferred toner image is passing through the secondary transfer portion N2, the through bias is applied to the secondary transfer roller 9. However, by the through bias being applied to the secondary transfer roller 9 upon at least a portion of the non-transferred toner image being passing through the secondary transfer portion N2, an appropriate effect can be obtained. In the present Embodiment, before the non-transferred toner image on the intermediary transfer belt 12 reaches the secondary transfer portion N2, the secondary transfer voltage is changed from the print bias to the through bias. And, after the non-transferred toner image has passed through the secondary transfer portion N2, and before the next sheet 2, which is fed from the double side unit 70 and onto which the toner image for the back side thereof is secondarily transferred, reaches the secondary transfer portion N2, the secondary transfer voltage is changed from the through bias to the print bias.

The through bias is a voltage of the opposite polarity to the print bias. In other words, the toner is not allowed to adhere to the secondary transfer roller 9 by electrostatic force. Thereafter, the secondary transfer for the back side of the third sheet is performed. By this, it becomes possible, without wasting the third sheet 2, of which the front side has already been printed, to print also the back side of the third sheet 2, and discharge the sheet 2 outside the machine of the image forming apparatus 100. Settings for the through bias will be hereinafter described in more detail.

### 7. Experiment for Appropriate Values for the Through Bias

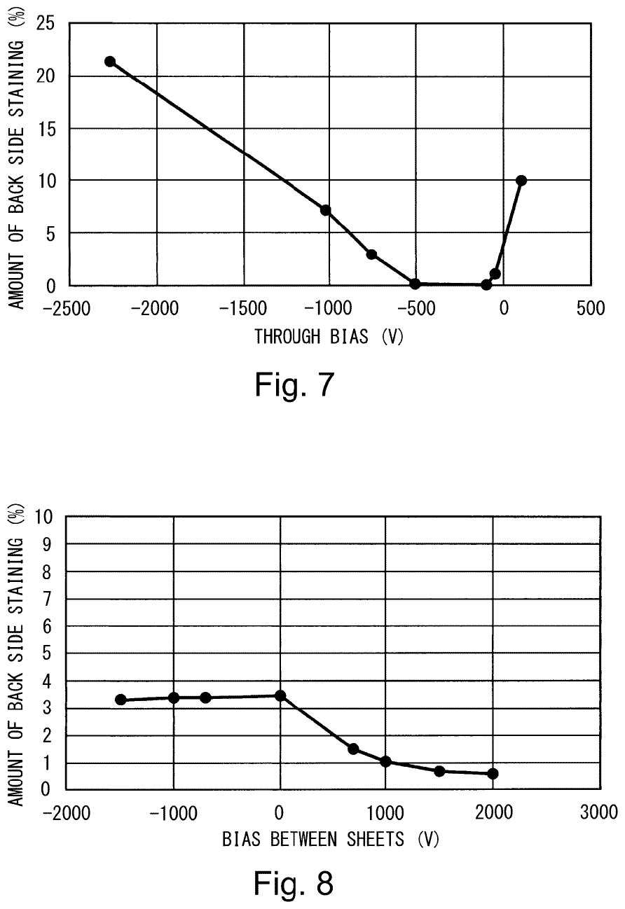

On effectiveness for suppressing the back side contamination with the through bias, an experiment was conducted. In the experiment, the three sheets 2 are set in the sheet feeding portion 1, the double side prints (two sheet alternate double side prints) for four sheets are performed, and an amount of the back side contamination of the third sheet 2 after the fourth sheet 2 becomes absent is evaluated. It is set so that formation a solid image (image of a maximum density level) of magenta is performed on the front side of the fourth sheet 2, and that the non-transferred toner image of magenta on the intermediary transfer belt 12 passes through the secondary transfer portion N2 by the fourth sheet 2 becoming absent. With changing a value of the through bias, which is applied to the secondary transfer roller 9 upon this non-transferred toner image of magenta on the intermediary transfer belt 12 being passing through the secondary transfer portion N2, the amounts of the back side contamination by magenta toner occurring on the third sheet 2 are measured. For the sheet 2, a bright white paper GF-C081 (marketed by Canon Marketing Japan Inc.) is used. In addition, the amount of the back side contamination is measured using a whiteness meter TC-6DS/A30 (manufactured by Tokyo Denshoku Co., Ltd.). Incidentally, the experiment is conducted in an environment of a temperature of 23° C. and a relative humidity of 55%. In addition, for the experiment, the process cartridge 22 with a remaining life of 50% or more is used. The results are shown in FIG. 7.

When the through bias are −500 V through −100 V, the amounts of the back side contamination become 1% or less, and the back side contamination is at a level barely visible. However, when the through bias is set to −750 V, the amount of the back side contamination becomes 3%, and the back side contamination becomes visible. In addition, when the through bias is set to −1000 V, the amount of the back side contamination becomes 7%, and the back side contamination becomes clearly visible. On the other hand, when the through bias is set to −50 V, the amount of the back side contamination becomes 1.2%, and the minor back side contamination may occur but is barely visible and at an allowable level. However, when the through bias is set to +100 V, the amount of the back side contamination becomes 10%, and the back side contamination becomes clearly visible.

From the experimental results as described above, it is found that when the amount of the back side contamination is 1% or less, it is a level barely noticeable to a user. In addition, it is also found that when the through bias is −500 V through −100 V, it is possible to suppress the amount of the back side contamination to 1% or less.

Next, charge amounts of the toner adhered to the secondary transfer roller 9 in the cases in which the back side contamination occurred are measured. During the aforementioned experiment, the operation of the imaging forming apparatus 100 is stopped urgently upon the non-transferred toner image of magenta on the intermediary transfer belt 12 being passing through the secondary transfer portion N2, and the charge amounts of the magenta toner adhered onto the secondary transfer roller 9 are measured. The measurements are performed using E-SPART Analyzer (manufactured by Hosokawa Micron Corporation). Incidentally, for comparison, the charge amount of the magenta toner on the intermediary transfer belt 12 before passing through the secondary transfer portion N2 and the charge amount of the magenta toner adhered onto the secondary transfer roller 9 are measured. Results are shown in Table 1.

TABLE 1

| | |
|---|---|
| On intermediary | Through bias |

| | transfer member | −1000 V | +100 V |
|---|---|---|---|
| Charge amount of | −35 | +40 | −30 |
| toner (μC/g) | | | |

The charge amount of the magenta toner on the intermediary transfer belt 12 before reaching the secondary transfer portion N2 was −35 μC/g. In addition, the charge amount of the toner adhered onto the secondary transfer roller 9 when the through bias was −1000 V was +40 μC/g. On the other hand, the charge amount of the toner adhered onto the secondary transfer roller 9 when the through bias was +100 V was −30 μC/g.

This may be because in the case in which the through bias is −1000 V, electric discharge occurs between the toner on the intermediary transfer belt 12 and the secondary transfer roller 9, and the toner, of which the charge polarity is reversed to be positive polarity, is adhered to the secondary transfer roller 9. On the other hand, in the case in which the through bias is +100 V, it may be considered that the toner of negative polarity on the intermediary transfer belt 12 is electrostatically attracted and adhered to the secondary transfer roller 9.

From the results as described above, it is found that in order to suppress the toner of the non-transferred toner image on the intermediary transfer belt 12 from adhering to the secondary transfer roller 9, it is appropriate to set the through bias as follows. That is, it is found that it is appropriate to apply, to the secondary transfer roller 9, as the through bias, a voltage which is the same polarity as the normal charge polarity of the toner (opposite polarity to the print bias) and of which an absolute value is less than a discharging threshold value. In addition, the through bias applied to the secondary transfer roller 9 is preferably −500 V through −100 V. If the through bias applied to the secondary transfer roller 9 is greater than −100 V and less than 0 V, a potential difference in the secondary transfer portion N2 may become insufficient, and a level of the effectiveness for the suppression of the back side contamination becomes a little lower. In general, a voltage at which the electric discharge starts (discharge start voltage, discharging threshold value) Vth is determined, based on Paschen's law, by a following formula.

$$V th = f ( p \times d ) ( where , p is gas pressure ( Torr ) , d is a distance between electrodes ( m ) )$$

It is appropriate for the through bias applied to the secondary transfer roller 9 to have the same polarity as the normal charge polarity of the toner (opposite polarity to the print bias) and for the absolute value thereof to be less than the discharge start voltage. In the configuration in the present Embodiment, when the voltage applied to the secondary transfer roller 9 is −500 V through −100 V, an absolute value of the potential difference between the driving roller 18 and the secondary transfer roller 9, which constitute the secondary transfer portion N2, becomes less than the discharging threshold value. As a result, it becomes possible to suppress that the toner of negative polarity on the intermediary transfer belt 12 from adhering to the secondary transfer roller 9 and allow that toner to pass through the secondary transfer portion N2. Therefore, it becomes possible to achieve the level of the back side contamination which is barely visible to a user. Incidentally, the voltage, of which the absolute value is less than the discharging threshold value, is not limited to the above range, but varies, based on Paschen's law, depending on an atmospheric pressure in the use environment and a distance between the intermediary transfer belt 12 and the secondary transfer roller 9.

Next, a similar experiment described above was conducted with setting so that a solid image of a secondary color of yellow and magenta instead of magenta is formed on the front side of the fourth sheet 2, and the amount of the back side contamination occurring on the third sheet 2 was measured. As a result, it became the same as the results of the amount of the back side contamination in the case in which the solid image of the primary color of magenta is formed (FIG. 7), and it is confirmed that the amount of the back side contamination becomes 1% or less when the through bias is −500 V through −100 V. Incidentally, upon observing the toner adhered to the secondary transfer roller 9 when the through bias is −1000 V, the adhered toner was almost the magenta toner and adhesion of the yellow toner was barely observed. This may be considered due to the following reason. That is, an upper layer of the solid image of the secondary color on the intermediary transfer belt 12 is covered by the magenta toner. Therefore, it may be considered that electric discharge occurred between the magenta toner on the intermediary transfer belt 12 and the secondary transfer roller 9, and substantially only the magenta toner, whose charge polarity is reversed to be positive polarity, is adhered to the secondary transfer roller 9. On the other hand, when the through bias is set to +500 V, onto the secondary transfer roller 9, adhesion of both of the magenta toner and the yellow toner was observed. This may be considered because both of the magenta toner and the yellow toner of negative polarity on the intermediary transfer belt 12 are attracted to the through bias of positive polarity and adhered to the secondary transfer roller 9.

From the results as described above, with the configuration in the present Embodiment, when the through bias is −500 V through −100 V, even for the solid image of the secondary color, it becomes possible to suppress the electric discharge between the toner on the intermediary transfer belt 12 and the secondary transfer roller 9, and suppress the occurrence of the back side contamination. In addition, from the results as described above, it is found that also for other images such as a solid image of tertiary color, a text/fine line image and a halftone image, the same effect can be obtained.

And by setting the through bias −500 V through −100 V, it becomes possible to suppress the adhesion of the toner to the secondary transfer roller 9, so that the necessity for performing the cleaning operation for the secondary transfer roller 9 in the sheet interval is reduced.

For example, in the case in which the through bias is −1000 V, the toner of positive polarity is adhered to the secondary transfer roller 5. Therefore, in this case, over a period of at least a period of one round of the secondary transfer roller 9 or longer, it becomes necessary to apply the secondary transfer voltage of positive polarity to the secondary transfer roller 9, or apply the secondary transfer voltage of positive polarity and negative polarity alternately. In other words, in this case, it becomes necessary for a distance of the sheet interval to be the length of one round of the secondary transfer roller 9 (56.5 mm) or longer. When making the sheet interval wide in advance in case the sheet 2 in the sheet feeding portion 1 becomes absent during performance of the double side print in this manner, the productivity of the prints is decreased.

In contrast, in the present Embodiment, in the case in which the sheet 2 in the sheet feeding portion 1 becomes absent during performance of the double side print, upon the non-transferred toner image on the intermediary transfer belt 12 being passing through the secondary transfer portion N2, as the through bias, the voltage, which has the same polarity as the normal charge polarity of the toner (opposite polarity to the print bias) and whose absolute value is less than the discharging threshold value, is applied. By this, it becomes possible to suppress the adhesion of the toner of the non-transferred toner image to the secondary transfer roller 9. Therefore, in the configuration in which the sheet interval is shorter than the length of one round of the secondary transfer roller 9 in order to enhance the productivity of the prints, even if the toner image is secondarily transferred to the sheet 2, which is fed from the double side unit 70, immediately after the non-transferred toner image on the intermediary transfer belt 12 has passed through the secondary transfer portion N2, the back side contamination can be suppressed. By this, it becomes possible to realize both of the suppression of the decrease in the productivity of the prints and the suppression of the back side contamination in the case in which the sheet 2 in the sheet feeding portion 1 becomes absent during performance of the double side print.

Incidentally, the values for the through bias are not limited to the values in the present Embodiment, but may be changed corresponding to the use environment and/or the charge amount of the toner. In addition, the values for the through bias may also be changed corresponding to an electrical resistance of the intermediary transfer belt 12 and an electrical resistance of the secondary transfer roller 9. To the secondary transfer roller 9, as the through bias, by applying the voltage which has the same polarity as the normal charge polarity of the toner (opposite polarity to the print bias) and of which the absolute value is less than the discharging threshold value, the same effect can be obtained.

In addition, in the present Embodiment, it has been described when the double side print continuation process is performed in the case in which the sheet 2 in the sheet feeding portion 1 becomes absent during performance of the double side print job. The operation in the present Embodiment to suppress the back side contamination in the double side print continuation process is also applicable to when the double side print continuation process is performed in a case in which a jam occurs during the performance of the double side print job. In this case, for example, when the occurrence of the jam is detected by the registration sensor 19, etc., the operation of the image forming apparatus 100 is once stopped by the engine control portion 200. And, typically, after the sheet 2 which caused the jam is removed by a user (operator), the operation of the image forming apparatus 100 is resumed by the engine control portion 200. In this operation after the resumption, the engine control portion 200 can control to perform the double side print continuation process which is the same as those described above. By this, it becomes possible to obtain the same effect as the case in which the sheet 2 in the sheet feeding portion 1 becomes absent during performance of the double side print job.

In addition, in the present Embodiment, of the driving roller (secondary transfer inner roller) 18 and the secondary transfer roller (secondary transfer outer roller) 9, which constitute the secondary transfer portion N2, the secondary transfer voltage is applied to the secondary transfer roller 9 by the secondary transfer power source 134, and the driving roller 18 is electrically grounded. In contrast, it may be configured that, of the secondary transfer inner roller and the secondary transfer outer roller, which constitute the secondary transfer portion N2, the secondary transfer voltage is applied by the secondary transfer power source 134 to the secondary transfer inner roller, and the secondary transfer outer roller is electrically grounded. In this case, to the secondary transfer inner roller, the voltage of the same polarity as the normal charge polarity of the toner as the print bias may be applied. In addition, in this case, to the secondary transfer inner roller, as the through bias, the voltage which has opposite polarity to the normal charge polarity of the toner (opposite polarity to the print bias) and of which the absolute value is less than the discharging threshold value may be applied. In other words, in the double side print continuation process, the through bias, which is a predetermined bias, which makes the secondary transfer outer roller to be a potential of the normal charge polarity side of the toner to the secondary transfer inner roller, and makes the absolute value of the potential difference between the secondary transfer inner roller and the secondary transfer outer roller be less than the discharging threshold value may be applied by the secondary transfer power source 134 to the secondary transfer portion N2.

In addition, in the present Embodiment, it has been described that the case in which the sheet interval during double side print is shorter than the length of one round of the secondary transfer roller 9 as an example. However, even in a case in which the sheet interval during double side print is the same as or longer than the length of one round of the secondary transfer roller 9, by using the same through bias as in the present Embodiment, it becomes possible to suppress the adhesion of the toner of the non-transferred toner image to the secondary transfer roller 9. By this, it becomes not necessary to perform discharging of the toner from the secondary transfer outer roller 9 after the non-transferred toner image has passed through the secondary transfer portion N2. Therefore, even in the configuration in which the sheet interval during double side print is the same as or longer than the length of one round of the secondary transfer roller 9, it is possible to apply the control using the through bias in the same way as in the present Embodiment in the double side print continuation process.

As such, in the present Embodiment, the image forming apparatus 100 includes the image forming portion S which forms the toner image on the image bearing member (photosensitive drum) 5 with the toner having the predetermined polarity as the normal charge polarity, the circulatable and movable intermediary transfer member (intermediary transfer belt) 12 to which the toner image is primarily transferred from the image bearing member 5 at the primary transfer portion N1, the inner roller (driving roller) 18 provided in the inner peripheral surface side of the intermediary transfer member 12, the outer roller (secondary transfer roller) 9 in contact with the inner roller 18 via the intermediary transfer member 12 and which forms the secondary transfer portion N2 at which the toner image is secondarily transferred to the sheet 2 from the intermediary transfer member 12, the applying portion (secondary transfer power source) 134 which applies the bias to the secondary transfer portion N2, the feeding portion (sheet feeding portion) 1 in which the sheet 2 is set, the conveyance portion (sheet feeding roller) 40 which conveys the sheet from the feeding portion 1 toward the secondary transfer portion N2, the double side conveyance portion (double side unit) 70 which reverses the front side and the back side of the sheet 2 which has passed through the secondary transfer portion N2 and to convey the sheet 2, to the secondary transfer portion N2, and the control portion (engine control portion) 200 which controls the image forming portion S, the applying portion 134, the conveyance portion 40 and the double side conveyance portion 70 so as to perform the double side print in which the toner image is secondarily transferred to the first side and the second side of the sheet 2 from the intermediary transfer member 12, and after the first toner image formed on a first image formation area on the intermediary transfer member is secondarily transferred to the first side of the first sheet 2 conveyed to the secondary transfer portion N2 by the conveyance portion 40, the second toner image formed on a second image formation area on the intermediary transfer member is secondarily transferred to the second side of the second sheet 2 conveyed to the secondary transfer portion N2 by the double side conveyance portion 70. In the present Embodiment, the control portion 200 is capable of controlling so that when performing the double side print, in the case in which the first sheet 2 is not conveyed to the secondary transfer portion N2, the continuation process is performed in which the second toner image is secondary transferred to the second side of the second sheet 2. And, the control portion 200 controls so that in the case of performing the continuation process, while the first image formation area passes through the secondary transfer portion N2, the predetermined voltage, which makes the outer roller be at the potential of the predetermined polarity side to the inner roller and makes the absolute value of the potential difference between the inner roller and the outer roller be less than the discharging threshold value, is applied to the secondary transfer portion N2 by the applying portion 134. In the present Embodiment, when performing the double side print, the first period from when the trailing end of the first sheet 2 in the conveyance direction has passed through the secondary transfer portion N2 until when the leading end of the second sheet 2 in the conveyance direction reaches the secondary transfer portion N2 is shorter than the second period when the outer roller makes one round. The above predetermined bias is preferably a bias which makes the absolute value of the potential difference between the inner roller 18 and the outer roller 9 100 V or more and 500 V or less. In addition, in the present Embodiment, the control portion 200 controls to perform the continuation process in the case in which the first sheet 2 is not conveyed to the secondary transfer portion N2 due to the absence of the sheet 2 set in the feeding portion 1. However, the control portion 200 can also control to perform the continuation process in the case in which the first sheet 2 is not conveyed to the secondary transfer portion N2 due to the occurrence of the jam of the sheet 2 in the conveyance passage of the sheet 2 from the feeding portion 1 to the secondary transfer portion N2. In addition, in the present Embodiment, the applying portion 134 applies the bias to the secondary transfer portion N2 via the outer roller 9. In addition, in the present Embodiment, the inner roller 18 is grounded.

As described above, according to the present Embodiment, it becomes possible to, while suppressing the decrease in the productivity of the prints, suppress the back side contamination in the case in which the double side print continuation process is performed.

### Embodiment 2

Next, another Embodiment of the present invention will be described. The basic configuration and operation of the image forming apparatus in the present Embodiment are the same as those of the image forming apparatus in the Embodiment 1. Therefore, in the image forming apparatus in the present Embodiment, to those elements having functions or configurations that are the same as or corresponding to those of the image forming apparatus in the Embodiment 1, the same reference numerals as in the Embodiment 1 will be attached, and detailed description thereof will be omitted.

In the present Embodiment, a sheet interval during double side print is longer than a length of one round of a secondary transfer roller 9. Specifically, in the present Embodiment, while an outer diameter of the secondary transfer roller 9 is 18 mm and the length of one round of the secondary transfer roller 9 (peripheral length) is 56.5 mm, the sheet interval during double side print is 80 mm.

Normally, toner of a toner image which is primarily transferred onto an intermediary transfer belt 12 is charged to negative polarity. Therefore, as described in the Embodiment 1, by applying a voltage, which has negative polarity and of which an absolute value is less than a discharging threshold value, to the secondary transfer roller 9 as a through bias, it becomes possible to suppress adhesion of the toner to the secondary transfer roller 9. However, for example, in a case in which a process cartridge 22 is used until a last stage of a lifetime thereof, due to deterioration of the toner, the toner, of which the charge property deviate from the normal charge property, comes to exist in a small amount but at a certain percentage. Such toner is typically the toner which is charged to the opposite polarity to the normal charge polarity, and here is also referred to as “reversed toner”.

For example, considering the case described in the Embodiment 1, in which the fourth sheet 2 becomes absent during performance of the double side print for four sheets. The reversed toner of positive polarity as described above may be, even if the through bias of −300 V is applied to the secondary transfer roller 9, by being electrostatically adsorbed to the secondary transfer roller 9 side, adhered to a surface of the secondary transfer roller 9. And, when a print bias of positive polarity is applied to the secondary transfer roller 9 upon performing the secondary transfer of the toner image onto the back side of the third sheet, the reversed toner of positive polarity, which has been adhered to the secondary transfer roller 9, receives electrical repulsion force, and is adhered to the back side of the sheet 2, which results in a back side contamination.

Here, an experiment to evaluate an amount of the back side contamination, which is the same as that described in the Embodiment 1, was conducted. For the experiment, the process cartridge 22 whose remaining lifetime is 10% is used. In advance, using the E-SPART Analyzer, when charge distribution of magenta toner immediately after the primary transfer onto the intermediary transfer belt 12 was measured, it was confirmed that there was the reversed toner which is charged to positive polarity, though an amount thereof is small.

In this experiment, the through bias is set to −300 V. And, after the fourth sheet 2 becomes absent, during a period from when a non-transferred toner image (a toner image of a solid magenta image) for a front side of a fourth sheet has passed through a secondary transfer portion N2 until when the toner image for a back side of a third sheet reaches the secondary transfer portion N2 (a period corresponding to a sheet interval), with changing the voltage applied to the secondary transfer roller 9 (here, also referred to as a “sheet interval bias”), the amounts of the back side contamination in the third sheet 2 are evaluated. Incidentally, the toner image for evaluation, an evaluation environment and a measuring device in the present Embodiment are the same as those in the experiment described in the Embodiment 1. The results are shown in FIG. 8.

First, in a case in which the sheet interval bias is 0 V, the amount of the back contamination is 3.5%. When the sheet interval bias is set to +700 V, the amount of the back side contamination is reduced to 1.5%. In addition, when the sheet interval bias is set to +1000 V or higher, the amount of the back side contamination becomes 1% or less and can be suppressed to a level barely visible. On the other hand, when the sheet interval bias is set to negative polarity, improvement in the back side contamination is hardly found, and the amount of the back side contamination transitions at about 3%.

From the experimental results as described above, it is found that upon applying the through bias, the reversed toner adhered to the secondary transfer roller 9 from the intermediary transfer belt 12 can be moved, by applying the voltage of +1000 V or higher as the sheet interval bias to the secondary transfer roller 9, by causing the reversed toner to be electrostatically repelled, from the secondary transfer roller 9 to the intermediary transfer belt 12. The sheet interval bias applied to the secondary transfer roller 9 has a tendency that an effect thereof saturates upon being increased to a certain degree, and in the configuration in the present Embodiment, +2000 V or lower is sufficient for the sheet interval bias. In the present Embodiment, an absolute value of the sheet interval bias is less than an absolute value of the print bias.

On the other hand, in cases in which the sheet interval bias of negative polarity is applied to the secondary transfer roller 9, it is found to be as following. That is, the reversed toner adhered to the secondary transfer roller 9 continues to be adsorbed electrostatically to the secondary transfer roller 9. Therefore, upon the print bias of positive polarity being applied to the secondary transfer roller 9 during secondary transfer of the toner image for the back side of the third sheet, the reversed toner is moved from the secondary transfer roller 9 to the sheet 2, which results in the back side contamination.

Therefore, in the case in which the sheet interval during double side print is longer than the length of one round of the secondary transfer roller 9, the voltage (sheet interval bias) of opposite polarity to the normal charge polarity of the toner (same polarity as the print bias) is applied to the secondary transfer roller 9 in the sheet interval. By this, it becomes possible to cause the reversed toner adhered to the secondary transfer roller 9 to be moved from the secondary transfer roller 9 to the intermediary transfer belt 12, and to suppress the back side contamination. The reversed toner moved from the secondary transfer roller 9 to the intermediary transfer belt 12 can be collected by the belt cleaning device 15.

The reversed toner may be generated at the last stage of the lifetime of the process cartridge 22 (when the toner is deteriorated) or when the image forming apparatus 100 (the process cartridge 22) is used in a high temperature and high humidity environment, etc.

Thus, in the present Embodiment, the image forming apparatus 100 is configured to be capable of performing the double side print in a first mode and in a second mode.

In the first mode, from a standpoint of the productivity of the prints, the sheet interval is set shorter than the length of one round of the secondary transfer roller 9. And in the case in which the sheet 2 in the sheet feeding portion 1 becomes absent during performance of the double side print, as described in the Embodiment 1, the through bias is applied to the secondary transfer roller 9 upon the non-transferred toner image on the intermediary transfer belt 12 is passing through the secondary transfer portion N2. By this, the back side contamination is suppressed.

On the other hand, in the second mode, the sheet interval is set longer than the length of one round of the secondary transfer roller 9. And in the case in which the sheet 2 in the sheet feeding portion 1 becomes absent during performance of the double side print, as described in the Embodiment 1, the through bias is applied to the secondary transfer roller 9 upon the non-transferred toner image on the intermediary transfer belt 12 is passing through the secondary transfer portion N2. In addition, after the non-transferred toner image on the intermediary transfer belt 12 passes through the secondary transfer portion N2, during a period corresponding to the sheet interval between the sheet 2, onto which the non-transferred toner image is expected to be transferred, and the sheet 2, which is fed from the double side unit 70, the sheet interval bias is applied to the secondary transfer roller 9. In other words, during the period from when the non-transferred toner image has passed through the secondary transfer portion N2 until when the next sheet 2, which is fed from the double side unit 70 and onto which the toner image for the back side thereof is secondarily transferred, reaches the secondary transfer portion N2, the sheet interval bias is applied to the secondary transfer roller 9. The sheet interval bias is preferably applied, in order to clean over an entire periphery of the secondary transfer roller 9, over a period of one round of the secondary transfer roller 9 or longer. However, in at least a portion of the period corresponding to the sheet interval, over a period in which the sheet interval bias is applicable, the sheet interval bias may be applied to the secondary transfer roller 9, and an appropriate effect may be obtained. The sheet interval bias is the voltage of opposite polarity to the normal charge polarity of the toner (the same polarity as the print bias).

In other words, as the sheet interval bias, another predetermined bias, which makes the secondary transfer outer roller be at a potential of the opposite polarity side to the normal charge polarity of the toner to the secondary transfer inner roller, is applied to the secondary transfer portion N2 by the secondary transfer power source 134. By this, the back side contamination is suppressed. Incidentally, as described in the Embodiment 1, the same applies also to the case in which the double side print continuation process is performed because the jam occurs during performance of the double side print.

Here, it may be configured that the first mode and the second mode is automatically switched by the engine control portion 200 based on information on a usage condition of the process cartridge 22 and/or a temperature and a humidity of an installed environment of the image forming apparatus 100. Or, it may be configured so that a user (operator) selects between the first mode and the second mode. As described above, while the reversed toner is unlikely to occur during normal use, but may occur at the last stage of the lifetime of the process cartridge 22 and/or during use in the high temperature and high humidity environment. Therefore, under the normal use environment, by selecting the first mode, it becomes possible to obtain sufficient suppression effect for the back side contamination and enhance the productivity of the prints. On the other hand, under the use environment in which the occurrence of the reversed toner is expected as described above, by selecting the second mode, although the productivity of the prints is decreased from that in the first mode, it becomes possible to suppress the back side contamination caused by the reversed toner.

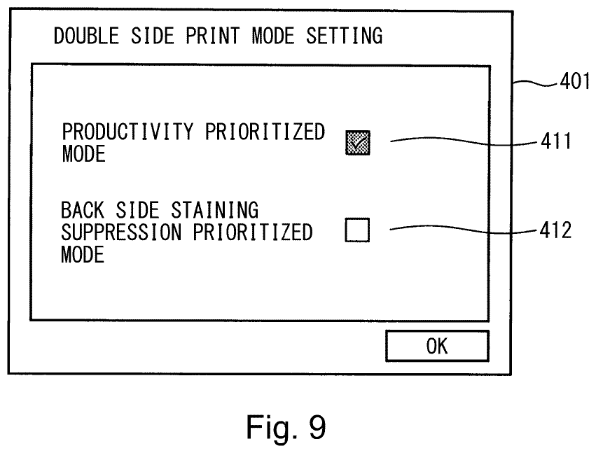

FIG. 9 is a schematic view of an example of a setting screen 401 which is displayed on the operating and display portion 205 in the case in which it is configured that the user can select the mode for the double side print.

As shown in FIG. 9, the setting screen 401 is provided with a first selection portion 411 for selecting the first mode described above (productivity prioritized mode) and a second selection portion 412 for selecting the second mode described above (back side contamination suppression prioritized mode). The user may select either mode in light of the usage condition of the image forming apparatus 100 (usage history of the process cartridge 22, environment, etc.). Incidentally, it may be configured that the setting screen 401 as shown in FIG. 9 is displayed when the setting screen 401 is called out by a predetermined operation by the user through the operating and display portion 205. In addition, by default, for example, the first mode may be selected. The engine control portion 200 controls to perform a double side print job according to the mode for the double side print selected through the setting screen 401.

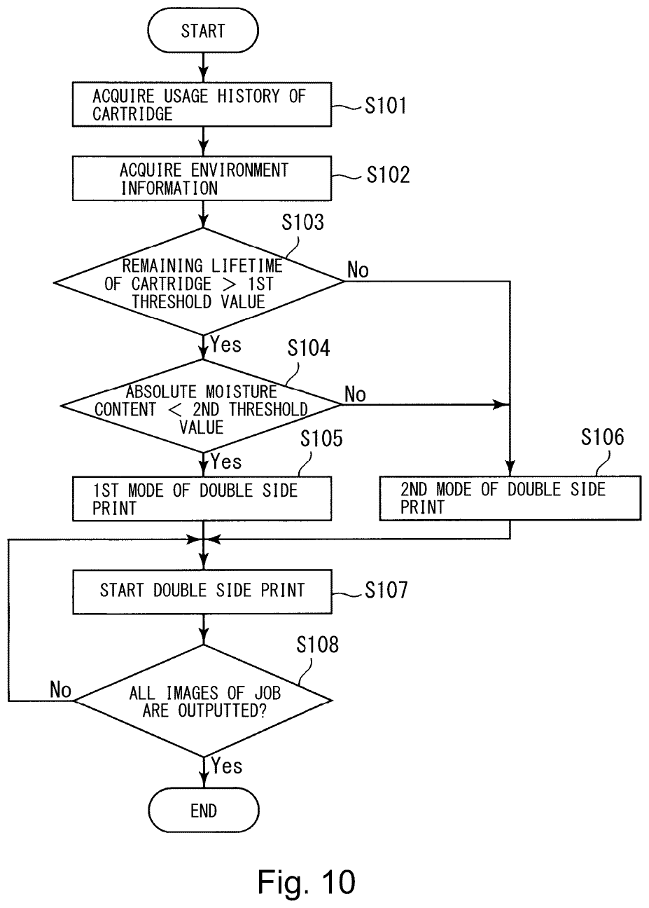

In addition, FIG. 10 is a flowchart diagram illustrating an example of a control procedure for the double side print job, which includes a mode switching control in the case in which the engine control portion 200 selects the mode for the double side print.

First, the engine control portion 200, upon information for the double side print job (start instruction, image information, etc.) being input from the operating and display portion 205 or an external device, acquires information on the usage history of the process cartridge 22 from a parts counter 60 (FIG. 3) (S101). As the information on the usage history (accumulated usage amount) of the process cartridge 22, for example, information on a remaining amount of the toner (or used amount of the toner) in the developing device 8, a number of rotations and/or rotation time of a rotating member in the developing device 8, a number of rotations and/or rotation time of the photosensitive drum 5, etc. may be used. As long as deterioration of the developing device 8 (more specifically, the toner) due to the usage thereof can be estimated, any indicator may be used. These information may be used with combined arbitrarily and, as a remaining life of the process cartridge 22, etc., may be sequentially stored in the parts counter 60, which is configured to include a storage portion. For these methods for acquiring (detecting) the information on the usage history of the process cartridge 22 (developing device 8), any method, for example, such as a known method may be used. In addition, the engine control portion 200 acquires a detection result of a temperature and a humidity (environment information) by an environment sensor 50 (S102). The engine control portion 200 can calculate an absolute moisture content based on the temperature and the humidity detected by the environment sensor 50.

The engine control portion 200 determines, based on the acquired information on the usage history of the process cartridge 22, whether or not a value of the remaining life of the process cartridge 22 is greater than a predetermined first threshold value (S103). The first threshold value may be set in advance in accordance with a tendency, with which the reversed toner gets likely to occur due to the deterioration of the toner, etc. In addition, if the engine control portion 200 determines in S103 that the remaining life is greater than the first threshold value (“Yes”), then determines, based on the absolute moisture content, which can be calculated from the acquired temperature and humidity, whether or not the absolute moisture content is less than a predetermined second threshold value (S104). The second threshold value may be set in advance in accordance with a tendency with which the reversed toner gets likely to occur under the high temperature and high humidity environment. If the engine control portion 200 determines that the absolute moisture content is less than the second threshold value (“Yes”) in S104, then proceeds the process to a process of S105.

If “Yes” in S103 and S104, then the engine control portion 200 decides to perform the double side print job in the first mode (S105). On the other hand, if “No” in S103 or S104 (the remaining life is the first threshold value or less and the absolute moisture content is the second threshold value or more), then the engine control portion 200 decides to perform the double side print job in the second mode (S106). And the engine control portion 200 starts the image formation for the double side print job in the mode set in S105 or S106 (S107), and if all outputs of the images specified in the job are completed, then terminates the operation for the job (S108).

Incidentally, the mode for the double side print job may be selected based on either one of the information on the usage history of the process cartridge 22 (developing device 8) and the environment.

In addition, in S103, for example, if the values of the remaining lives of all of the process cartridges 22 are greater than the first threshold value, then it may be determined to be “Yes”. In addition, in S103, for example, if the value of the remaining life of at least one of the process cartridges 22 is the first threshold value or less, then it may be determined to be “No”. However, it is not limited to this, but based on likeliness of the occurrence of the back side contamination, etc., in the case of switching between the first mode and the second mode, a number of the process cartridges 22 (developing devices 8), which is the predetermined remaining life or less, to determine as “No” in S103 may be set as appropriately.

In addition, in the present Embodiment, as the information on the usage history of the process cartridge 22 (developing device 8), the remaining life (for example, 100% when new and 0% when the lifetime is reached) is used, however, a usage amount (for example, 0% when new and 100% when the lifetime is reached) may be used. In this case, it may be configured to control to perform the double side print in the first mode if the usage amount of the process cartridge 22 is less than a predetermined threshold value, and in the second mode if the usage amount of the process cartridge 22 is the predetermined threshold value or more. It is sufficient that the modes can be switched depending on whether the information (value) on the usage history of the process cartridge 22 (developing device 8) crosses the threshold value or not.

In addition, in the present Embodiment, it is determined whether or not the absolute moisture content is less than the predetermined threshold value, however, it may be determined whether or not the absolute moisture content is greater than the predetermined threshold value. In this case, it may be configured to control to perform the double side print in the second mode if the absolute moisture content is determined to be greater than the predetermined threshold value (“Yes”), and in the first mode if the absolute moisture content is determined to be the predetermined threshold value or less (“No”). It is sufficient that the modes can be switched depending on whether the information (value) on the environment crosses the threshold value or not.

In this manner, in the present Embodiment, the control portion 200 can control, in the continuation process, to perform the double side print in the first mode in which the first period from when the trailing end of the first sheet 2 in the conveyance direction reaches the secondary transfer portion N2 until when the leading end of the second sheet 2 in the conveyance direction reaches the secondary transfer portion N2 is shorter than the second period when the outer roller 9 makes one round, and in the second mode in which the first period is longer than the second period. And, in the present Embodiment, when performing the double side print in the second mode in the case of performing the continuation process, the control portion 200 controls to cause the applying portion 134 to apply the predetermined bias (through bias) to the secondary transfer portion N2 while the first image formation area, in which the non-transferred toner image on the intermediary transfer member may exist, passes through the secondary transfer portion N2, and to cause the applying portion 134 to apply another predetermined bias, which makes the outer roller 9 be at the potential of the opposite polarity side to the predetermined polarity (normal charge polarity of the toner) to the inner roller 18 from when the first image formation area has passed through the secondary transfer portion N2 until when the second sheet 2 reaches the secondary transfer portion N2. The another predetermined bias described above is preferably a bias which makes the absolute value of the potential difference between the inner roller 18 and the outer roller 9 at least 1000 V. In addition, the control portion 200 can control so that the another predetermined voltage is applied over at least the period when the outer roller 9 makes one round.

In addition, the image forming apparatus 100 may include the input portion (operating and display portion) 205 for inputting the instruction to the control portion 200 based on the operation of the operator, and the control portion 200 can control to selectively perform the double side print in the first mode or in the second mode in accordance with the instruction input through the input portion 205. In addition, the image forming apparatus 100 may include the acquiring portion (parts counter) 60 which acquires the information on the usage history of the developing device 8 provided in the image forming portion S and supplying the toner to the image bearing member 5, and the control portion 200 can control to selectively perform the double side print in the first mode or in the second based on the acquisition result by the acquiring portion 60. In this case, the control portion 200 can control to perform the double side print in the first mode in the case in which the accumulated usage amount of the developing device 8 indicated by the acquisition result is a first usage amount, and to perform the double side print in the second mode in the case in which the accumulated usage amount indicated by the acquisition result is a second usage amount larger than the first usage amount. In addition, the image forming apparatus 100 may include the acquiring portion (environment sensor) 50 which acquires the information on the environment, and the control portion 200 can control to selectively perform the double side print in the first mode or in the second mode based on the acquisition result by the acquiring portion 50. In this case, the control portion 200 can control to perform the double side print in the first mode in a case in which a humidity indicated by the acquisition result is a first humidity, and to perform the double side print in the second mode in a case in which the humidity indicated by the acquisition result is a second humidity higher than the first humidity.

As described above, according to the present Embodiment, it becomes possible, while suppressing the decrease in the productivity of the prints, to suppress the back side contamination in the case in which the double side print continuation process is performed in accordance with the usage condition of the image forming apparatus 100, etc.

Next, another Embodiment of the present invention will be described. The basic configuration and operation of the image forming apparatus in the present Embodiment are the same as those of the image forming apparatus in the Embodiment 1. Therefore, in the image forming apparatus in the present Embodiment, to those elements having functions or configurations that are the same as or corresponding to those of the image forming apparatus in the Embodiment 1, the same reference numerals as in the Embodiment 1 will be attached, and detailed description thereof will be omitted.

In the present Embodiment, a configuration associated with application of a primary transfer voltage and a secondary transfer voltage is different from the Embodiment 1.

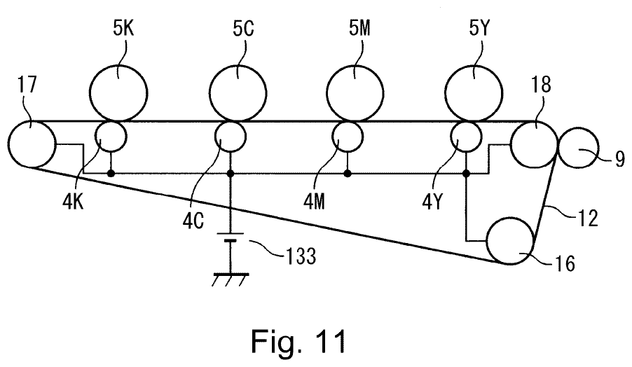

FIG. 11 is a schematic view for describing the configuration associated with the application of the primary transfer voltage and the secondary transfer voltage in the present Embodiment. In the present Embodiment, an intermediary transfer belt 12 has a multilayer structure of at least two or more layers. In the present Embodiment, with respect to a surface (front layer) of the intermediary transfer belt 12 to which the photosensitive drum 5 contact, a surface (back surface layer) of the intermediary transfer belt 12 which contacts the primary transfer roller 4 has a lower electrical resistance. In the present Embodiment, for the intermediary transfer belt 12, a belt of which a surface resistivity of the front layer is 1.0×10¹⁰ Ω/sq. and the surface resistivity of the back surface layer is 1.0×10⁵ Ω/sq. is used.

In addition, in the present Embodiment, a driving roller 18 for rotationally driving the intermediary transfer belt 12 is disposed as an opposing roller to a secondary transfer roller 9, and a primary transfer power source 133 for applying a voltage to primary transfer rollers 4Y, 4M, 4C and 4K is connected thereto. In addition, also to other stretching rollers 16 and 17, which stretch the intermediary transfer belt 12, the primary transfer power source 133 is connected in the same manner as the driving roller 18. In the Embodiment 1, the driving roller 18 and the other stretching rollers 16 and 17 are all directly grounded. In contrast, in the present Embodiment, to the driving roller 18 and the other stretching rollers 16 and 17, the primarily transfer voltage is applied. In this configuration, upon primarily transferring a toner image onto the intermediary transfer belt 12, the primary transfer voltage is applied from the primary transfer power source 133 to each of the primary transfer rollers 4Y, 4M, 4C and 4K, the driving roller 18 and the other stretching rollers 16 and 17. By this, it becomes possible to maintain a potential of the intermediary transfer belt 12 above a predetermined potential or higher, to suppress fluctuation in a primary transfer potential at each primary transfer portion N1, and to obtain stable primary transfer performance.

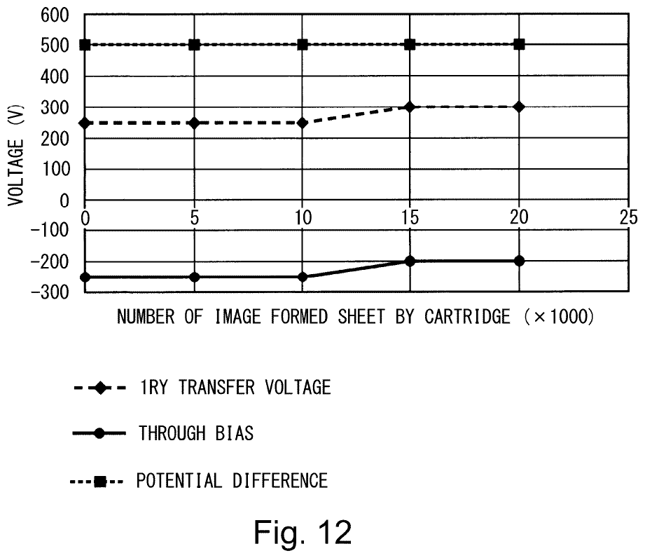

In the present Embodiment, since the primary transfer voltage is applied to the driving roller 18 as the secondary transfer opposite roller, it becomes necessary to consider an optimal through bias to suppress the back side contamination in the case in which the double side print continuation process is performed. FIG. 12 shows a control example of the through bias in the present Embodiment.

For example, upon performing the operation of the image forming sequence shown in FIG. 6 in a use environment in which a temperature is 23° C. and a humidity is 55%, as the primarily transfer voltage, 250 V is applied to each of the primary transfer roller 4, the driving roller 18 and other stretching rollers 16 and 17. And when the fourth sheet 2 becomes absent, −250 V is applied to the secondary transfer roller 9 as the through bias. Upon a non-transferred toner image is passing through a secondary transfer portion N2, a potential difference between the driving roller 18 and the secondary transfer roller 9 becomes 500 V. In other words, a voltage which is the same polarity as the toner and less than a discharge start voltage is applied to the secondary transfer roller 9. Therefore, it becomes possible to suppress adhesion of the toner to the secondary transfer roller 9.

In addition, as shown in FIG. 12, the primary transfer voltage may be changed in accordance with a usage condition of a process cartridge 22. This is because deterioration of the toner progresses due to repeated use thereof, and to obtain good transferability using a higher primary transfer voltage. For example, after an accumulated usage amount of the process cartridge 22 has reached 15,000 sheets as a number of sheets of the image formation, in a case in which the same image forming operation is performed, 300 V is applied as the primary transfer voltage. In this case, by applying −200 V as the through bias, as in the above case, it becomes possible to maintain the potential difference between the driving roller 18 and the secondary transfer roller 9 at 500 V. By this, it becomes possible to suppress the adhesion of the toner to the secondary transfer roller 9. By applying the through bias as shown in FIG. 12, it becomes possible to maintain a state in which the back side contamination is 1% or less throughout a lifetime of the process cartridge 22.

In this manner, by adjusting the potential difference between the secondary transfer roller 9 and the driving roller 18 so as to be in a relationship less than the discharge start voltage according to Paschen's law, and by applying the voltage of the same polarity as the normal charge polarity of the toner to the secondary transfer roller 9, it becomes possible to suppress the occurrence of the back side contamination in the case in which the double side print continuation process is performed.

Incidentally, as also for the sheet interval bias, it may be configured as in the same manner as the through bias described above, and a potential difference between the primary transfer voltage may be set as described in the Embodiment 2.

In addition, in the present Embodiment, the configuration in which the primary transfer voltage is applied to the driving roller (secondary transfer inner roller) 18 has been described, however, for example, it may be a configuration in which the driving roller (secondary transfer inner roller) 18 is electrically grounded via a voltage maintaining element such as a resistor and a varistor. In this case as well, as for the through bias and the sheet interval bias, by setting the potential difference between the driving roller (secondary transfer inner roller) 18 and the secondary transfer roller (secondary transfer outer roller) 9 in the same manner as described above, it becomes possible to obtain the same effect.

In this manner, in the present Embodiment, the image forming apparatus 100 includes a voltage maintaining means (the primary transfer power source 133, the resistor, the varistor, etc.) which maintains the potential of the inner roller 18 to the potential of the opposite polarity to the predetermined polarity. In the present Embodiment, the voltage maintaining means is constituted by the power source (the primary transfer power source) 133 which applies the bias to the primary transfer member (primary transfer roller) 4 which transfers the toner image from the image bearing member 5 to the intermediary transfer member 12.

As described above, even in the image forming apparatus 100 which includes the configuration associated with the application of the primary transfer voltage and the secondary transfer voltage as in the present Embodiment, by applying the present invention thereto, it becomes possible to obtain the same effect as in the Embodiments 1 and 2.

As described above, the present invention has been described according to the specific Embodiments, however, the present invention is not limited to the above Embodiments.

The settings for the through bias described in the Embodiments described above are also effective for suppressing any toner, which is non-transferred to the sheet on the intermediary transfer member, from adhering to the secondary transfer outer roller. In the Embodiments described above, it is suppressed that the toner of the non-transferred toner image on the intermediary transfer member in the double side print continuation process is adhered to the secondary transfer outer roller. Similarly, it is possible to suppress that any toner, such as toner of a toner image during calibration for image quality adjusting purpose and toner of a toner image remaining on the intermediary transfer member due to a jam during performance of a continuous single side print job, is adhered to the secondary transfer outer roller.

In addition, in the Embodiment 2, upon performing the double side print continuation process in the second mode, in the case in which the double side print continuation process is performed, the sheet interval bias is applied to the secondary transfer roller during the period corresponding to the sheet interval after the non-transferred toner image has passed through the secondary transfer portion. In contrast, for example, in the second mode, at least a portion (or may also be all) of the sheet intervals except in the case in which the double side print continuation process is performed, the sheet interval bias may be applied to the secondary transfer roller. By this, it becomes possible to clean the secondary transfer roller by causing the reversed toner, etc., which may be adhered to the secondary transfer roller due to the performance of the print, to be moved to the intermediary transfer belt in the sheet intervals.

In addition, the operations and displays described as being performed in the operating and display portion provided in the image forming apparatus in the Embodiments described above may be configured to be performed in an operating portion and/or a display portion of an external device, which is communicably connected to the image forming apparatus. In this case, the input/output portion, etc., provided in the image forming apparatus functions as an input portion to input signals for various types of settings, etc. to the control portion, and as an output portion to output signals for the control portion to perform various types of displays, etc.

According to the present invention, it becomes possible, while suppressing the decrease in the productivity of the prints, to suppress the back side contamination in the case in which the double side print continuation process is performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-112989, filed Jul. 12, 2024, which is hereby incorporated by reference herein in its entirety.

What is claimed is:

1. An image forming apparatus comprising:
an image forming portion configured to form a toner image on an image bearing member with toner having a predetermined polarity as a normal charge polarity;
a circulatable and movable intermediary transfer member to which the toner image is primarily transferred from the image bearing member at a primary transfer portion;
an inner roller provided in an inner peripheral surface side of the intermediary transfer member;
an outer roller in contact with the inner roller via the intermediary transfer member and configured to form a secondary transfer portion at which the toner image is secondarily transferred to a sheet from the intermediary transfer member;
an applying portion configured to apply a voltage to the secondary transfer portion;
a feeding portion in which the sheet is set;
a conveyance portion configured to convey the sheet from the feeding portion toward the secondary transfer portion;
a double side conveyance portion configured to reverse a front side and a back side of the sheet which has passed through the secondary transfer portion and to convey the sheet to the secondary transfer portion; and
a control portion configured to control the image forming portion, the applying portion, the conveyance portion and the double side conveyance portion so as to perform a double side print in which
the toner image is secondarily transferred to a first side and a second side of the sheet from the intermediary transfer member, and
after a first toner image formed on a first image formation area on the intermediary transfer member is secondarily transferred to a first side of a first sheet conveyed to the secondary transfer portion by the conveyance portion, a second toner image formed on a second image formation area on the intermediary transfer member is secondarily transferred to a second side of a second sheet conveyed to the secondary transfer portion by the double side conveyance portion,
wherein the control portion controls so that
when performing the double side print, in a case in which the first sheet is not conveyed to the secondary transfer portion, a continuation process is performed in which the second toner image is secondarily transferred to the second side of the second sheet, and
in a case of performing the continuation process, while the first image formation area passes through the secondary transfer portion, a predetermined voltage, which makes the outer roller be at a potential of the predetermined polarity side to the inner roller and makes an absolute value of a potential difference between the inner roller and the outer roller be less than a discharging threshold value, is applied to the secondary transfer portion by the applying portion.

2. An image forming apparatus according to claim 1, wherein when performing the double side print, a first period from when a trailing end of the first sheet in a conveyance direction has passed through the secondary transfer portion until when a leading end of the second sheet in the conveyance direction reaches the secondary transfer portion is shorter than a second period when the outer roller makes one round.

3. An image forming apparatus according to claim 2, wherein the control portion controls to perform the double side print in a first mode in which the first period is shorter than the second period and in a second mode in which the first period is longer than the second period, and
wherein when performing the double side print in the second mode in a case of performing the continuation process, the control portion controls to cause the applying portion to apply the predetermined voltage to the secondary transfer portion while the first image formation area passes through the secondary transfer portion, and to cause the applying portion to apply another predetermined voltage, which makes the outer roller a potential of an opposite polarity side to the predetermined polarity to the inner roller from when the first image formation area has passed through the secondary transfer portion until when the second sheet reaches the secondary transfer portion.

4. An image forming apparatus according to claim 1, wherein the predetermined voltage is a voltage which makes the absolute value of the potential difference between the inner roller and the outer roller 100 V or more and 500 V or less.

5. An image forming apparatus according to claim 3, wherein the another predetermined voltage is a voltage which makes the absolute value of the potential difference between the inner roller and the outer roller at least 1000 V.

6. An image forming apparatus according to claim 3, wherein the control portion controls so that the another predetermined voltage is applied over at least the second period when the outer roller makes one round.

7. An image forming apparatus according to claim 1, wherein the control portion controls to perform the continuation process in a case in which the first sheet is not conveyed to the secondary transfer portion due to absence of the sheet set in the feeding portion.

8. An image forming apparatus according to claim 1, wherein the control portion controls to perform the continuation process in a case in which the first sheet is not conveyed to the secondary transfer portion due to occurrence of a jam of the sheet in a conveyance passage of the sheet from the feeding portion to the secondary transfer portion.

9. An image forming apparatus according to claim 3, further comprising an input portion configured to input an instruction to the control portion based on an operation of an operator,
wherein the control portion controls to selectively perform the double side print in the first mode or in the second mode in accordance with the instruction input from the input portion.

10. An image forming apparatus according to claim 3, further comprising an acquiring portion configured to acquire information on a usage history of a developing device provided in the image forming portion and configured to supply the toner to the image bearing member,
wherein the control portion controls to selectively perform the double side print in the first mode or in the second mode based on an acquisition result by the acquiring portion.

11. An image forming apparatus according to claim 10, wherein the control portion controls to perform the double side print in the first mode in a case in which an accumulated usage amount of the developing device indicated by the acquisition result is a first usage amount, and
to perform the double side print in the second mode in a case in which the accumulated usage amount indicated by the acquisition result is a second usage amount larger than the first usage amount.

12. An image forming apparatus according to claim 3, further comprising an acquiring portion configured to acquire information on an environment,
wherein the control portion controls to selectively perform the double side print in the first mode or in the second mode based on an acquisition result by the acquiring portion.

13. An image forming apparatus according to claim 12, wherein the control portion controls to perform the double side print in the first mode in a case in which a humidity indicated by the acquisition result is a first humidity, and
to perform the double side print in the second mode in a case in which the humidity indicated by the acquisition result is a second humidity higher than the first humidity.

14. An image forming apparatus according to claim 1, wherein the applying portion applies the voltage to the secondary transfer portion via the outer roller.

15. An image forming apparatus according to claim 14, wherein the inner roller is grounded.

16. An image forming apparatus according to claim 14, further comprising a voltage maintaining means configured to maintain a potential of the inner roller to a potential of an opposite polarity side to the predetermined polarity.

17. An image forming apparatus according to claim 16, wherein the voltage maintaining means includes a power source which applies a voltage to the primary transfer portion to transfer the toner image from the image bearing member to the intermediary transfer member.
